(19) United States
(12) Patent Application Publication
(10) Pub. No.: US 2015/0184455 A1
(43) Pub. Date: Jul. 2, 2015

(54) Window Shade

(71) Applicant: Horizons Holdings, LLC, Middleton, WI (US)

(72) Inventors: David Perkowitz, Vernon Hills, IL (US); Dale R. Marks, Kenosha, WI (US)

(73) Assignee: Horizons Holdings, LLC, Middleton, WI (US)

(21) Appl. No.: 14/141,175

(22) Filed: Dec. 26, 2013

(51) Int. Cl. E06B 9/42

(52) U.S. Cl. CPC E06B 9/42

(57) ABSTRACT

A window shade system includes a headrail configured for mounting adjacent a window and a rotatable roller mounted to the headrail. The roller has a first end and a second end opposite the first end. The window shade system includes a support mechanism disposed between the first and second ends of the roller. The support mechanism has a first portion and a second portion. The first portion of the support mechanism is secured to the headrail and the second portion of the support mechanism is a bore through which the roller extends.

### CROSS REFERENCE TO RELATED APPLICATION

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Background

The present invention generally relates to window shades, and more particularly to a lift system for use with, for example, a Roman shade.

2. Description of the Background

Various types of window coverings are known, including roller shades and Roman shades, which are also generally referred to as blinds. Roman shades typically comprise a shade suspended from a headrail. The shading material, which may be formed from a variety of materials including paper, cloth, other fabrics, and plastic and wood members, is typically moved to a stowed configuration and maintained in such configuration by a cord attached to the shade at or near its bottom edge. The shade is then deployed by letting out the cord to lower the bottom edge and, with it, the remainder of the shade. The cord is typically disposed along an outer face of the shade, and may be attached to spaced portions of the shade to promote uniform folding of the shade as the shade is being raised by the cord.

The cord of such a blind can attract the attention of a child. An infant or toddler can become entangled in a loose cord, and may be strangled by placing his/her head between the cord and the shade. Therefore, improvements in blinds have been developed to reduce the risk of such tragedies. A blind with a safety arrangement is disclosed in Lin U.S. Patent Publication No. 2005/0092448. The blind comprises a headrail, a brake mechanism proximate the headrail, a pair of cord portions that pass through the brake mechanism, and a shade cloth. The shade cloth has a lower end secured to ends of the cord portions and the cord portions extend upwardly adjacent a rear face of the shade cloth through cord covers formed of a soft material, such as yarn. A plurality of spaced positioning elements are stitched to the cord cover and to the shade cloth. Pulling ends of the cord portions adjacent a front face of the shade cloth causes the positioning elements, except the topmost positioning element, to move upwardly, thereby causing the shade cloth to wrinkle upwardly. Also, the cord covers are contracted together. Lin notes that: “a dangerous ring will not be formed by the cord and the cord covers in operation.” However, Lin does not disclose the structure or configuration of the positioning elements, and therefore, does not teach in sufficient detail how such a blind may be satisfactorily constructed with materials that are aesthetically pleasing, easy to operate, and long-lasting in use. In this regard, the use of a material, such as a low-strength yarn, for the cord covers, can lead to wear and failure of the cord covers at the point(s) of attachment of one or more of the positioning elements to the shade cloth, thereby resulting in the possibility that the a dangerous loop could be formed.

The blind disclosed in Lin also requires a user to pull ends of the cord portions in order to raise and lower the shade. This arrangement results in exposed cords accessible from the front of the shade by a child, which is undesirable.

### SUMMARY

According to one aspect, a window shade system is disclosed. The window shade system includes a headrail configured for mounting adjacent a window. A rotatable roller is mounted to the headrail. The rotatable roller has a first end and a second end opposite the first end. A support mechanism is disposed between the first and second ends of the roller. The support mechanism has a first and a second portion. The first portion of the support mechanism is secured to the headrail and the second portion of the support mechanism has a bore through which the roller extends.

According to another aspect, a window shade is disclosed. The window shade has a headrail configured for mounting adjacent a window and a rotatable roller that is mounted to the headrail. The window shade also includes a shading material that has a first end attached to the headrail, a second end opposite the first end, and a face between the first and second ends. A cord is disposed adjacent the face and is secured to the roller wherein rotation of the roller causes the cord to be wound about or unwound from the roller for moving the shading material between a stowed position in which the shading material is collected adjacent the headrail and a deployed position in which at least a portion of the shading material extends away from the headrail. The window shade further includes a support mechanism disposed between a first end and a second end of the roller. The support mechanism has a first portion and a second portion. The first portion of the support mechanism is secured to the headrail and the second portion of the support mechanism has a bore configured to receive the roller.

Other aspects and advantages of this invention will be better appreciated from the following detailed description.

### BRIEF DESCRIPTION OF THE DRAWINGS

FIG. 1 comprises a rear isometric view of a window shade 10 in accordance with an embodiment of the present invention;

FIG. 2 comprises a fragmentary, elevational front view of the shade 10 of FIG. 1;

FIG. 3 comprises an enlarged fragmentary elevational front view, partly in section, of the shade 10 of FIGS. 1 and 2;

FIG. 4 comprises an exploded, fragmentary, isometric view of the shade 10 of FIGS. 1-3;

FIG. 5 comprises an enlarged, fragmentary, isometric view of the shroud 32 and encapsulated cord 26;

FIG. 6 comprises an enlarged, fragmentary rear isometric view of the window shade 10 of FIGS. 1-4;

FIG. 7 comprises an exploded, fragmentary, isometric rear view of an alternate blind 198;

FIG. 8 comprises an enlarged, fragmentary, isometric view of a flat spring 215;

FIG. 9 comprises an exploded, fragmentary, isometric rear view of an alternate window shade 220;

FIG. 10 comprises an exploded, fragmentary, isometric rear view of a further alternate window shade 260;

FIG. 11 comprises a fragmentary, elevational view of yet another embodiment of the present invention;

FIG. 12 comprises an enlarged, fragmentary, elevational view illustrating the clip of FIG. 11 in greater detail;

FIG. 13 comprises a sectional view taken generally along the lines 13-13 of FIG. 11;

FIGS. 14, 15, 25, 26, 28, and 29 are fragmentary, enlarged, elevational views illustrating further embodiments of the present invention;

FIG. 16 is a fragmentary elevational view illustrating yet another embodiment of the present invention;

FIG. 17 is a fragmentary elevational view illustrating still another embodiment of the present invention;

FIG. 18 is a fragmentary view illustrating another embodiment of the present invention utilizing multiple rollers;

FIGS. 19 and 24 are fragmentary elevational views illustrating other embodiments of the present invention;

FIGS. 20-22 are fragmentary, elevational views illustrating still further embodiments of the present invention;

FIG. 23 comprises an isometric view of the shade of FIG. 22;

FIG. 27 comprises an elevational view of a roller having springs disposed therein for use with the shade of FIG. 18;

FIG. 30 is a front isometric view illustrating another embodiment of the present invention;

FIG. 31 is a rear isometric view of the shade of FIG. 30;

FIG. 32 is a fragmentary elevational view illustrating a further embodiment of the present invention;

FIG. 33 is a fragmentary elevational view illustrating another embodiment of the present invention;

FIG. 34 is a sectional view taken generally along the lines 34-34 of FIG. 33;

FIG. 35 is a fragmentary elevational view illustrating a further embodiment of the present invention;

FIG. 36 is a sectional view taken generally along the lines 36-36 of FIG. 35;

FIG. 37 is a front elevation view of another embodiment of a roller;

FIG. 38 is a perspective side view of the roller of FIG. 37 with varying diameters;

FIG. 39 is a fragmentary perspective view of the roller of FIG. 37 with a cord attachment member and cord shown;

FIG. 40 is a fragmentary top plan view of the roller of FIG. 39 without a cord;

FIG. 41 is a side elevational view of the cord attachment member of FIG. 39;

FIG. 42 is a perspective view of a spring-loaded mechanism;

FIG. 43 is a fragmentary elevational view illustrating a further embodiment of the present invention.

FIG. 44 is a perspective view of a support member; and

FIG. 45 is a fragmentary elevational view of a roller having the support member of FIG. 44 and two cord attachment members.

### DETAILED DESCRIPTION OF THE DRAWINGS

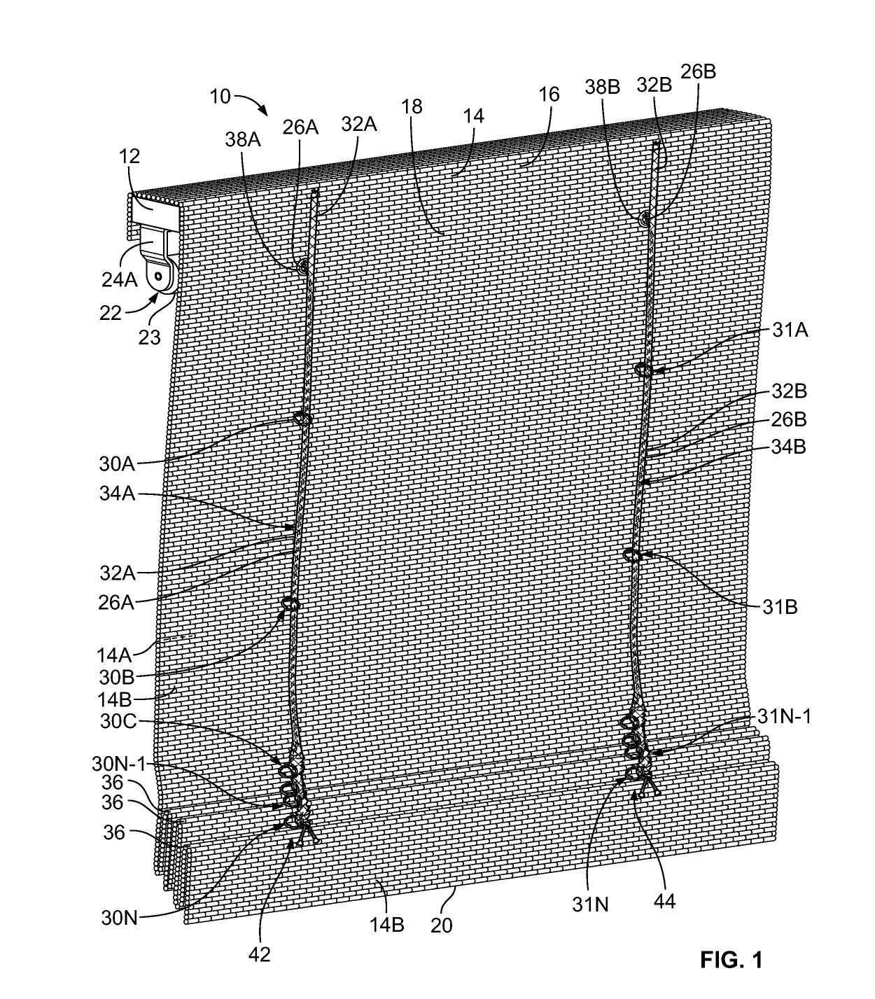

FIG. 1 depicts a Roman-type window shade 10, though it will become evident that the benefits of the present invention can be applied to other types of window shades. To facilitate the description of the shade 10 provided below, the terms “vertical,” “horizontal,” “front,” “rear,” “side,” “upper,” “lower,” “above,” “below,” etc., may be used, in which case such terms reference the viewpoint of an operator facing a window in or on or adjacent to which the shade 10 is installed. For example, the shade 10 is preferably adapted to be mounted adjacent or above a window or within a window casing to allow a shading material 14 of the shade 10 to hang vertically downward and serve as a window treatment for the window.

In the embodiment shown in FIG. 1, the shading material is formed of a plurality of wood sections 15. The wood sections 15 generally alternate between thin flat sections 15A and circular rod sections 15B. The wood sections 15 are held together by weaving cords 17.

Alternatively, the shading material 14 may be formed of a variety of materials and provide a range of shading effects. For example, the shading material 14 may be completely opaque or have some degree of translucency. Other nonlimiting examples of suitable materials for the shading material 14 include one or more pieces of paper, one or more pieces of cloth fabrics, wooden and bamboo slats, one or more metal pieces, and plastic materials. More generally, the shading material 14 may be formed from a single piece of material or multiple individual pieces of one or more materials held together in some manner to form a flexible structure. Depending on the intended installation, either or both of front and rear faces or surfaces 14A and 14B, respectively, of the shading material 14 can be decorative.

The shading material 14 has a first or upper end 16 attached to a headrail 12, wherein the latter is adapted to be horizontally mounted adjacent and/or above a window with any suitable type of hardware (not shown). As a result, the shading material 14 is suspended to hang downwardly from the headrail 12 so that a portion 18 of the material 14 is able to serve as a shade in front of the window. A second or lower end of the shading material 14 relative to the headrail 12 defines a lower edge 20 of the shade portion 18. The shading material 14 is movable between a stowed position in which the material 14 is collapsed and collected (preferably folded) beneath the headrail 12. For example, the entire shade portion 18 can be further raised from the position shown in FIG. 1 so that the remainder of the shade portion 18 between the headrail 12 and the folds 36 also becomes folded. By further lowering the shade portion 18 from the position shown in FIG. 1, the shading material 14 is movable to a partially or fully deployed position in which the material 14 is preferably capable of substantially or completely covering the window.

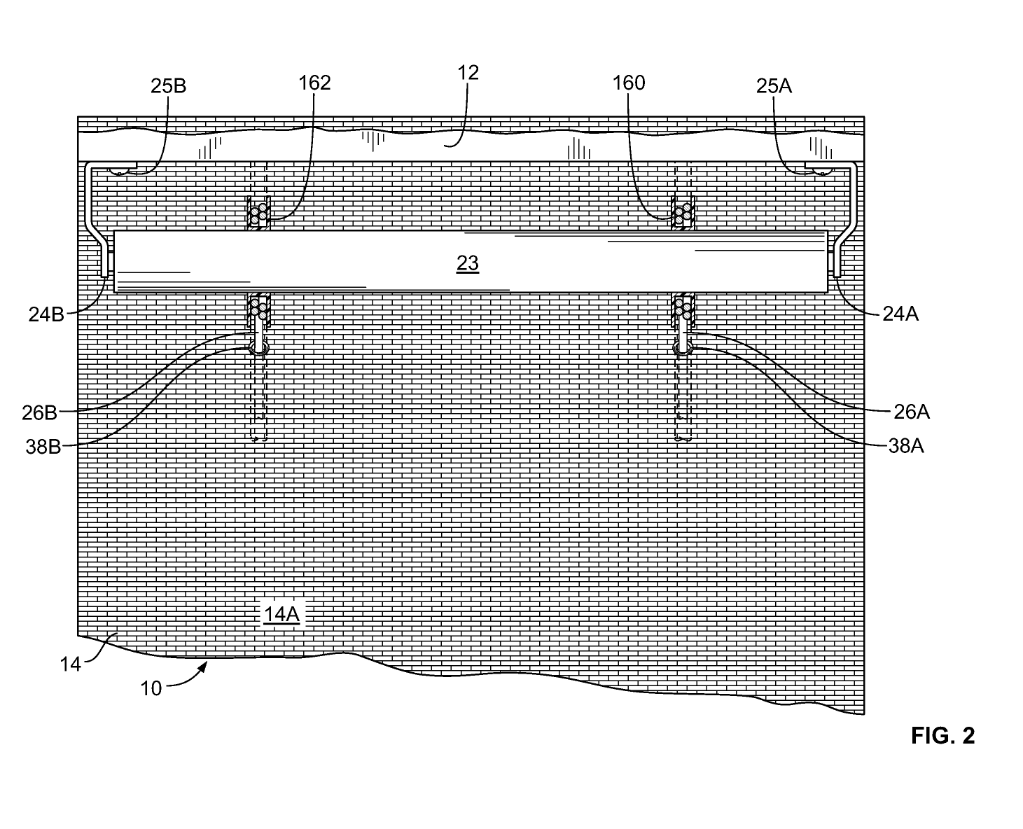

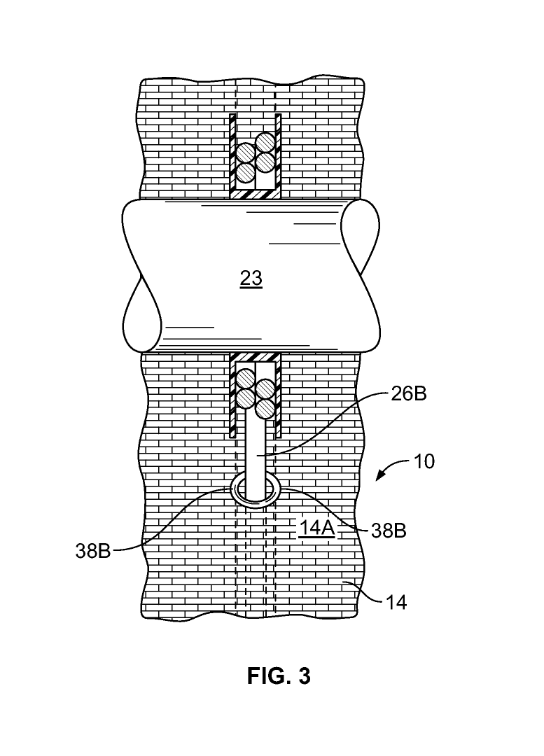

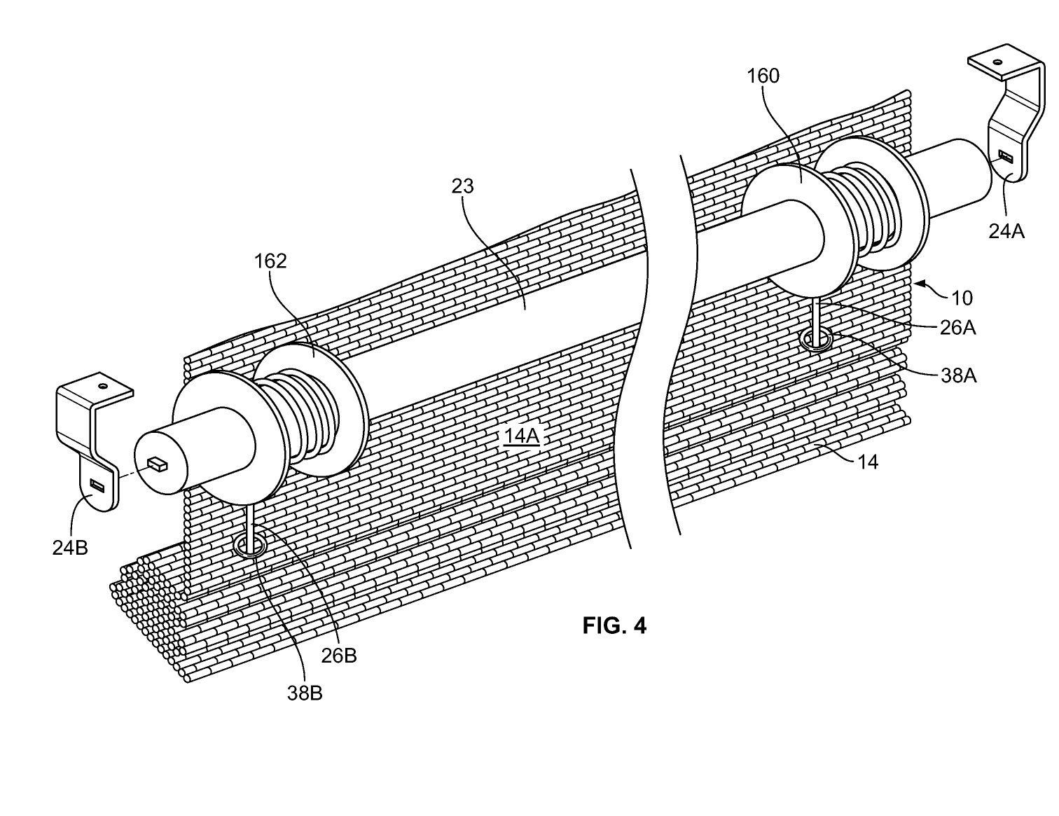

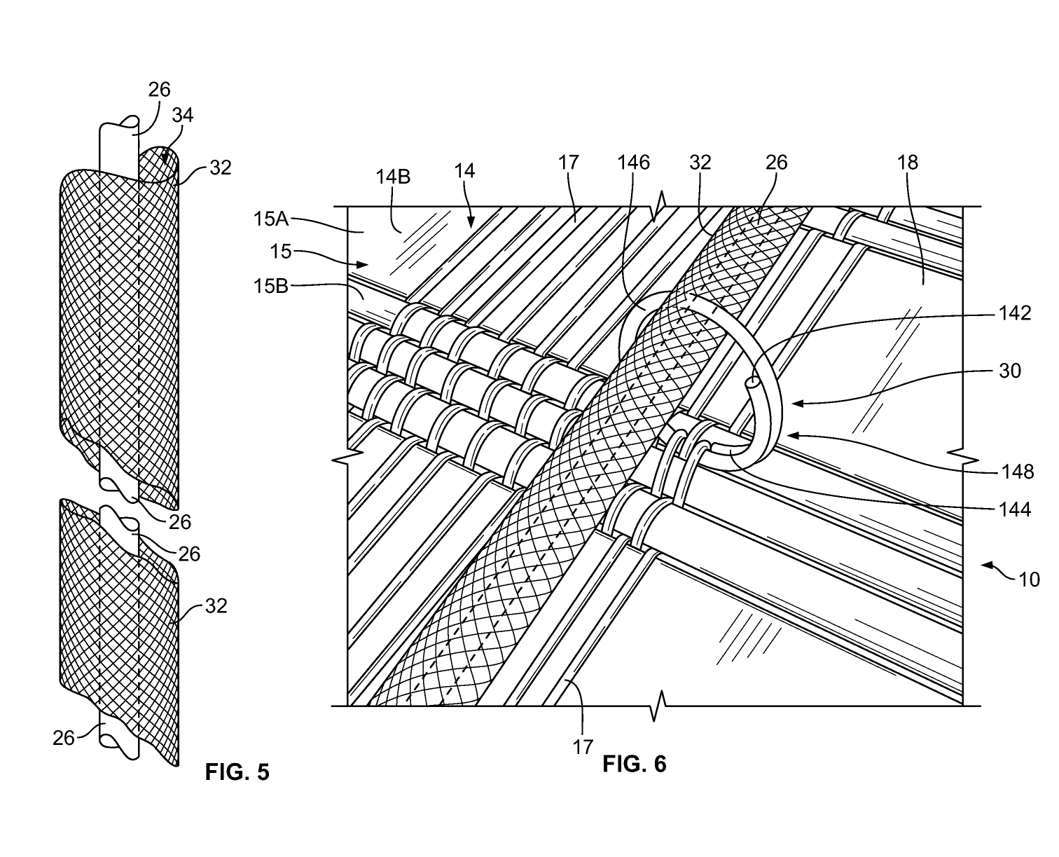

Referring also to FIGS. 2-5, the shade 10 further includes a mechanism 22 for raising and lowering the shading material 14 relative to the headrail 12. In the preferred embodiment, such a mechanism 22 comprises a roller 23 rotatably mounted beneath the headrail 12 by first and second side brackets 24A, 24B fastened by any suitable fasteners, such as screws 25A, 25B to the headrail 12. In the preferred embodiment, the roller 23 comprises a conventional spring-loaded shade roller conventionally used to take up and store flexible shade fabric or other shade material in wound-up fashion thereon. The roller 23 preferably includes substantially rectangular (or other shaped) rotationally spring-loaded rotatable spindles 21A, 21B that are keyed into like-shaped bores or apertures in the brackets 24A, 24B. This keying prevents relative rotation between the spindles 21 and the brackets 24 so that the spring loading of the spindles 21 permits spring forces to be transferred to the roller 23. It should be noted that the roller 23 may be rotatably mounted in another fashion and/or may be mounted to another structure, such as a window casing, as desired. Such a roller further has an internal clutch mechanism that permits a user to pull down on the shade material, position a lower end of the material, and release the material, whereupon the material remains at or moves to a stationary position at any of a plurality of discrete desired heights and is locked against further rotation that would otherwise result in further movement of the shading material. An example of such a roller 23 is sold by Frenk USA LLC of Fredericksburg, Va. One or more cords 26 (seen in the FIGS. as two cords 26A, 26B, although a different number may be used, depending upon the width of the shade 10) are secured to the rear face 14B of the shading material 14 above or adjacent the lower edge 20 of the shade portion 18. The cords 26A, 26B extend through grommets 38A, 38B that are crimped or otherwise secured about openings in the material 14. The cords transmit forces to the shading material 14, as noted in greater detail hereinafter. As discussed in greater detail below, collapsible shrouds 32A, 32B are sewn to or otherwise secured to the material 14 at spaced locations. As also illustrated in FIGS. 5 and 6, each shroud 32A, 32B preferably has a roughly tubular (i.e., hollow) shape and defines an internal passage 34A, 34B, respectively, that extends in a longitudinal direction downwardly adjacent the rear face 14B of the material 14. Each shroud 32A, 32B is loosely woven with gaps in the weave thereof. The cords 26A, 26B extend into the shrouds 32A, 32B, respectively, in the vicinity of the grommets 38A, 38B wherein each cord 26A, 26B passes through one of the gaps in the weave of the shrouds 32A, 32B. The cords 26A, 26B extend downwardly adjacent the rear face 14B and are preferably entirely encased in the collapsible shrouds 32A, 32B between the points at which the cords 26A, 26B respectively enter the shrouds 32A, 32B in the vicinity of the grommets 38A, 38B and lowermost locations 42, 44 of attachment of the cords 26A, 26B and shrouds 32A, 32B to the material 14, as illustrated in FIG. 1. The collapsible shrouds 32 are preferably constructed so that they are able to extend longitudinally as the material 14 is lowered toward the deployed position, as evident from those portions of the shrouds 32 disposed above the folds 36 in FIG. 1. The shrouds 32 are also preferably constructed so that they are able to collapse longitudinally as the material 14 is raised toward the stowed position, as is evident from those portions of the shrouds 32 disposed within the folded section of the shade portion 18 in FIG. 1. For this reason, the shrouds 32 are preferably fabricated from a loosely woven flexible material, for example, such that the cords 26 might be seen through the gaps in the shrouds 32. The loosely woven material can be formed by a variety of materials, with low-friction polymeric yarn materials being preferred to minimize friction with the cords 26. The polymeric yarn is preferably 100% polyester, and may be woven on a crochet or knitting machine. Preferably, the cords 26 are also made of polyester material so as to minimize frictional forces and allow the cords 26 and shroud 32 to slide easily past each other without undue wear.

The shrouds 32A, 32B may be attached to the upper end 16 of the material 14 with staples that extend into the headrail 12. The shrouds 32 may alternatively or in addition be sewn, bolted, nailed, glued, or otherwise attached to the upper end 16 and/or headrail 12. In a first embodiment seen in FIGS. 1 and 2, first and second pluralities of spaced cord guides 30A, 30B, 30C, . . . , 30N and 31A, 31B, 31C, . . . , 31N, respectively, are secured to the rear face 14B of the shading material 14. In the illustrated embodiment, the cord guides 30A-30N are preferably vertically aligned with one another, as are the cord guides 31A-31N.

Each shroud 32A, 32B is preferably secured to each of an associated plurality of guides 30A-30N and 31A-31N, respectively, and is further preferably secured to the material 14 in the vicinity of the grommets 38A, 38B at the upper end 16 of the material 14. Preferably, although not necessarily, the shrouds 32 are otherwise not attached to the material 14. Each cord 26A, 26B inside of the shroud 32A, 32B, respectively, is routed through associated uppermost guides 30A and 31A located in proximity to the headrail 12, through one or more associated intermediate cord guides 30B-30N-1 and 31B-31N-1, and is attached to associated lowermost cord guide 30N and 31N nearest the lower end 20 of the material 14. The shrouds 32 and cords 26 may be tied in a knot around the lowermost cord guides 30N and 31N. Preferably, the cords 26 and shrouds 32 are knotted together to the lowermost cord guides 30N and 31N to make one cohesive knot. In other embodiments, each cord 26 and shroud 32 may be knotted separately to the same or different portions of the associated cord guide 30N, 31N. Adhesive, bonding, or other means of attachment may also or alternatively be used. In each event, the portions of the shrouds 32 and the cords 26 disposed between adjacent pairs of cord guides 30, 31 are only able to be displaced a limited distance from the shading material 14, and such distance is determined at least in part by the spacing distance between adjacent cord guides 30A-30N and 31A-31N, and the resiliency of the cords 26 and/or shrouds 32.

Alternatively, the shrouds 32A, 32B and cords 26A, 26B may extend through the cord guides 30A-30N and 31A-31N and may be secured to the material 14 at locations below the lowermost cord guides 30N and 31N. In this event, each shroud 32A, 32B is secured to the associated cord guides 30A-30N and 31A-31N, respectively, and each cord 26A and 26B optionally extends through one or more of the associated cord guides 30A-30N and 31A-31N, respectively.

Preferably, the cord guides 30, 31 are identical to one another, and each cord guide 30A-30N and 31A-31N comprises a split metal ring, for example, the ring 30 seen in FIG. 6 attached to the shade 10 of FIG. 1. Other rigid material may also be used for the cord guide 30, 31, such as (but not limited to) plastic, paper, cardboard, glass and/or wood, although the preferred material is metal, such as steel. In the illustrated embodiment, each cord guide 30, 31 is approximately 1.27 centimeters (0.5 inches) in diameter and is formed of a material about 1.067 centimeters (0.042 inches) thick.

Referring specifically to FIG. 6, each cord guide 30, 31 includes a first end 142, a second end 144 and an intermediate portion 146 that connects the first end 142 and second end 144. The first end 142, second end 144 and intermediate portion 146 form a spiral having an overlapping portion 148 defining a partial double loop. Alternatively, the material may instead be arranged to form a full double loop, a partial triple loop, a full triple loop etc. Either end 142, 144 of the loop can be pried open relative to the other end to allow shroud material 32 or weaving cords 17 to be inserted and slid along the spiral until it becomes wholly engaged onto the ring. Alternatively, each cord guide 30, 31 may use a mechanism (not shown) to open and securely close the loop.

Each cord guide 30, 31 is attached to the shade 10 by inserting the first end 142 or the second end 144 of the cord guide between the weaving cords 17 and the shading material 14 and subsequently rotating the ring until the cord guide 140 is fully engaged about the weaving cords 17, and therefore with the shade 10. Each cord guide 30, 31 may similarly be attached to the shroud 32 by inserting the first end 142 or the second end 144 of the cord guide through loosely woven shroud material 32 between weaves thereof and rotating the ring 30, 31 and/or sliding the shroud 32 along the spiral contour of the ring, until the cord guide 30, 31 is fully engaged with the shroud 32. Preferably, the cord guide 30, 31 is attached to the shroud 32 such that the respective cord 26 passes through the hollow interior of the cord guide, thereby ensuring that the cords 26 are unable to become loose or be pulled loose and hang free from the material 14 and making the shade 10 less likely to pose a risk to children or others. The strength of the attachment of the shrouds 32 to the material 14 may be important because the stronger the method of attachment, the less chance there is that a child will be able to pull the collapsible shroud 32 off of the cord guides or the cord guides off of the shading material, thereby minimizing the chance that a child will be able to place his or her head between one of the collapsible shrouds 32 or cords 26 and the adjacent rear surface 14B of the material.

Referring next to FIGS. 2-4, first and second spools 160, 162 are fixed at spaced locations on the roller 23 adjacent the grommets 38A, 38B, respectively. The spools 160, 162 rotate with the roller 23 and the cords 26A, 26B are secured to the spools 160, 162, respectively. This attachment may be accomplished by threading the cords 26A, 26B through bores extending fully through the respective spool 160, 162 and the roller 23 and knotting the end of the cord 160, 162 to prevent removal of the cord from respective bore. Alternatively, any other attachment methodology and/or structure may be used. The cords 26A, 26B are wound about the spools 160, 162 and the cords 26A, 26B are kept in tension by the biasing force developed by the spring-loaded roller 23 and the weight of the shading material 14. This tension together with the clutch action of the roller 23 permit a user to grasp the shading material 14 (typically the lower end of the material 14) and pull down against the tensioning force, and thereby move the material 14 up or down. Specifically, the material may be pulled down to a desired level by the user to unwind a portion or all of the cords 26A, 26B from the spools 160, 162, respectively, and may be released, whereupon the material 14 remains substantially at the level at which the material was released due to the clutch action of the roller 23. Alternatively, the material 14 may be pulled down to release the clutch action of the roller 23 and guided to a desired higher level by the user whereupon a portion of the cords 26A, 26B are wound on the spools 160, 162, respectively, and the material 14 may thereafter be released after assuring that the clutch action of the roller 23 will prevent further roller retraction. The shade 10 is thus positioned and remains at the higher level. The spring action of the roller counterbalances at least some, if not all, of the weight of the blind so that operation is smooth and requires little to no force to be exerted by the user.

As the shade 10 is raised, the shade portion 18 collapses and collects in cascading folds 36 beneath the headrail 12 in typical fashion for Roman-type shades. As is evident from FIG. 1, the cord guides 30, 31 create the folds 36 and are disposed at corners or inflections of the folds 36 in the material 14 when the shade portion 18 is raised. While in the stowed position, the window in front of which the shade 10 is installed is typically (although not necessarily) substantially uncovered. Conversely, in the deployed position, the window in front of which the shade 10 is installed is typically (although not necessarily) substantially covered. During movement the cords 26 are able to travel freely upwardly and downwardly through the respective shrouds 32 as a result of the connection between the cords 26 and shade portion 18 being limited to a single attachment point (for example, the lowermost cord guides 30N, 31N), while the shrouds 32 have multiple connection points with the material 14 at the cord guides 30A-30N and 31A-31N.

It is preferred to encase the cords 26 within the collapsible shrouds 32 and to secure the shrouds to the material 14 at spaced locations so that the cords 26 are unable to become loose or be pulled loose and hang free from the material 14. Encapsulating the cords 26 within the collapsible shrouds 32 and securing the shrouds 32 to the cord guides 30, 31 makes the shade 10 less likely to pose a risk to children or others. To promote this safety feature further, the cord guides 30, 31 are preferably spaced sufficiently close together to preclude a child from placing his or her head between one of the collapsible shrouds 32 and the adjacent rear face 14B of the material 14. For this purpose, adjacent cord guides 30 and adjacent cord guides 31 are preferably spaced, for example, not more than eight inches (about twenty centimeters) apart, and more preferably no more than about six inches (about fifteen centimeters) apart or less.

It should be noted that the blind 10 may utilize different cord guides and/or different cord and/or shroud materials. For example, any combination of such elements disclosed in U.S. Patent Application Publication No. 2011/0100569, the disclosure of which is expressly incorporated herein, may be used in the present invention. Also, any number of shroud-encased cords 26 and associated spools may be used to assist in raising/lowering the blind 10, as necessary or desirable. Also, one or more of the cords 26 may be replaced by tapes (i.e., narrow, flat, elongate strips of material). Still further, more than one spring may be used in the roller 23 and/or one or more springs may be located outside of the roller 23, e.g., between the roller 23 and one or both of the brackets 24A, 24B and/or between a portion of the shading material 14 and one or both of the brackets 24, and the particular combination of springs and overall upward force exerted by the spring bias on the roller 23 may be selected in dependence upon the weight of the blind 10 and/or to achieve a particular operational effect. One spring or set of springs may be disposed at or adjacent one end of the roller 23 and another spring or set of springs may be disposed at or adjacent another end of the roller 23. Additional structures might be used to provide an upward force to permit the shading material 14 to be positioned at a desired level. For example, outwardly-facing (i.e., laterally-extending) members may be secured in any suitable fashion to the shading material 14 and may extend into slots in side members fixed to or forming a part of the side members of a window casing. Springs may be disposed in recesses communicating with the slots and may bear against the outwardly-facing members to provide an upward spring bias to the shading material 14. A clutch mechanism may be included to permit the shading material to be raised by a user to a desired level and released, whereupon the shading material remains at the desired level. Such an apparatus may be used in combination with the roller 23, if desired.

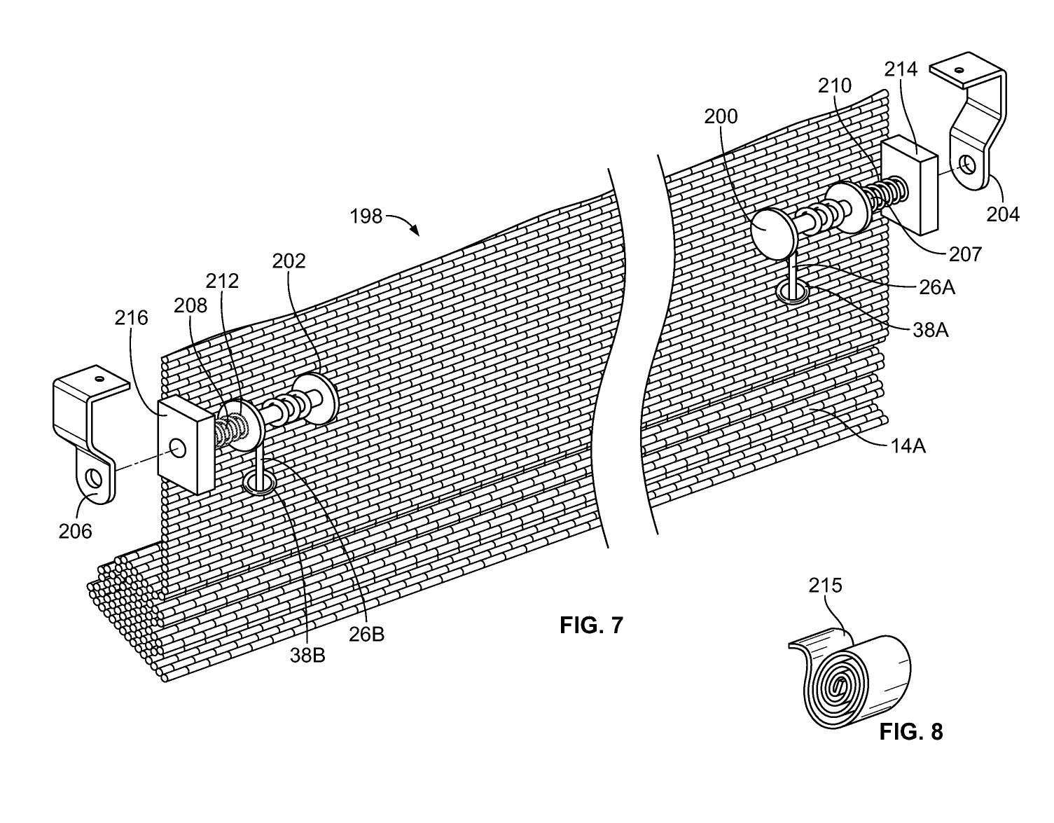

Still further, the precise tensioning elements that assist in the raising and lowering of the blind without the need for manually graspable cords could be changed. For example, the spring-loaded roller 23 may be replaced by a different tensioning element altogether, if desired. For example, referring to FIG. 7, a blind 198 omits the roller 23 entirely, and the cords 26 may be secured to and wound about spools 200, 202 carried by brackets 204, 206 secured to a headrail (not shown, but identical to the headrail 12 described above) and/or to a window casing (not shown). Specifically, the spools 200, 202 may be rotatably carried on spindles 207, 208, respectively, and may be spring-biased by torsion springs 210, 212, respectively. The spindles may be coupled to external clutch mechanisms 214, 216 secured by any suitable means to the brackets 204, 206, respectively. If desired one of the clutch mechanisms 214, 216 may be omitted and/or the clutch mechanism(s) may be disposed inside the spool(s) 200, 202. Again, the clutch mechanism(s) allow the shading material 14 be positioned and remain at a desired level.

Alternatively, the cords 26 may extend about pulleys and into side pockets of the window jamb or casing and may be attached to counterweights that ride up and down in the pockets, similar to the construction of casement windows roughly pre-1960's.

In any of the embodiments disclosed herein, one or more pulleys, idlers, guides, etc. may be used in the path of the cords 26, as necessary or desirable regardless of the tensioning element that is used.

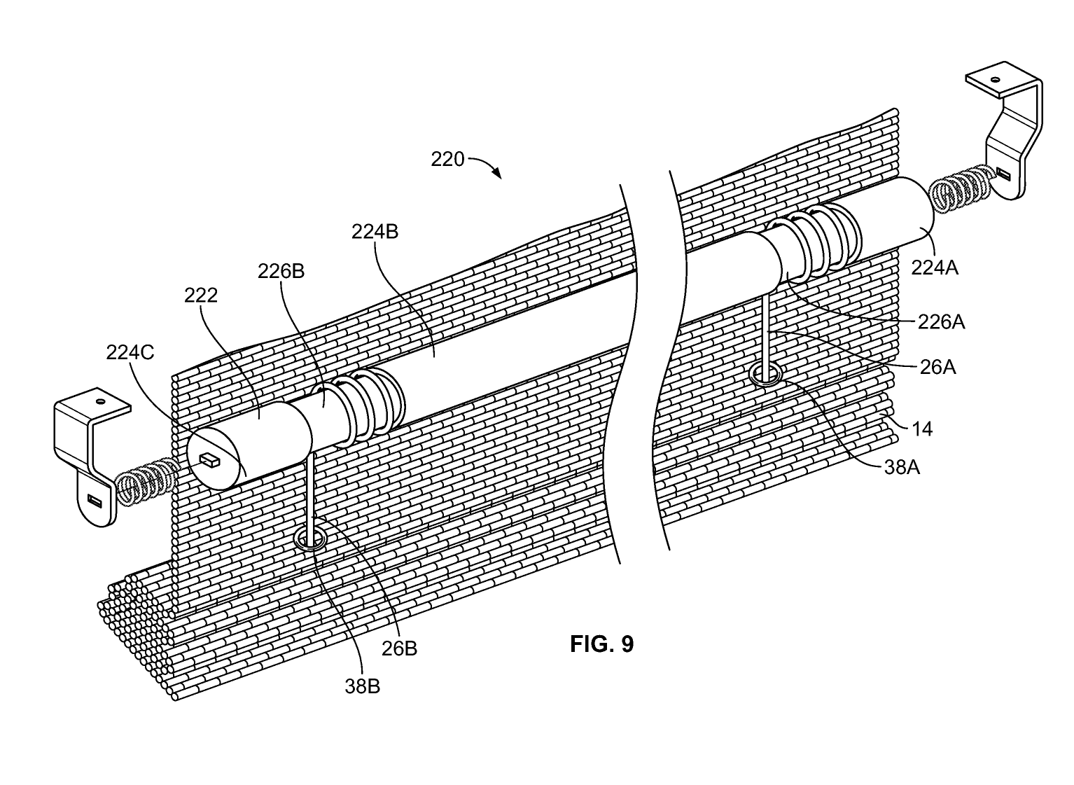

Also, the spools of the embodiment of FIGS. 1-4 may be replaced by other elements or omitted altogether, in which case the cords 26A, 26B may be secured directly to the roller 23 and may be wound thereon. The roller 23 may have guiding structures to guide the cords 26 as the cords are taken up and wound about the roller 23. The roller 23 may have any suitable dimensions and shape; for example, the roller may have a diameter larger or smaller that that shown in the FIGS. and need not have a constant diameter over the full length thereof. Such a shade 220 is illustrated in FIG. 9, which illustrates a roller 222 having main portions 224A-224C and reduced diameter portions 226A, 226B between the main portions 224A, 224B and 224B, 224C, respectively. The cords 26A, 26B are secured in any suitable fashion such as that described above to the reduced diameter portions 226A, 226B, respectively, and wound thereabout. The roller 222 may have internal springs and/or may be coupled by external torsion springs 230, 232 to brackets 234, 236, respectively. The roller 222 may have an internal clutch mechanism as in the embodiment of FIGS. 1-4 and may operate identically thereto, with the exception that the cords are not taken up by spools, but are instead collected in loops in the reduced diameter portions 226A, 226B.

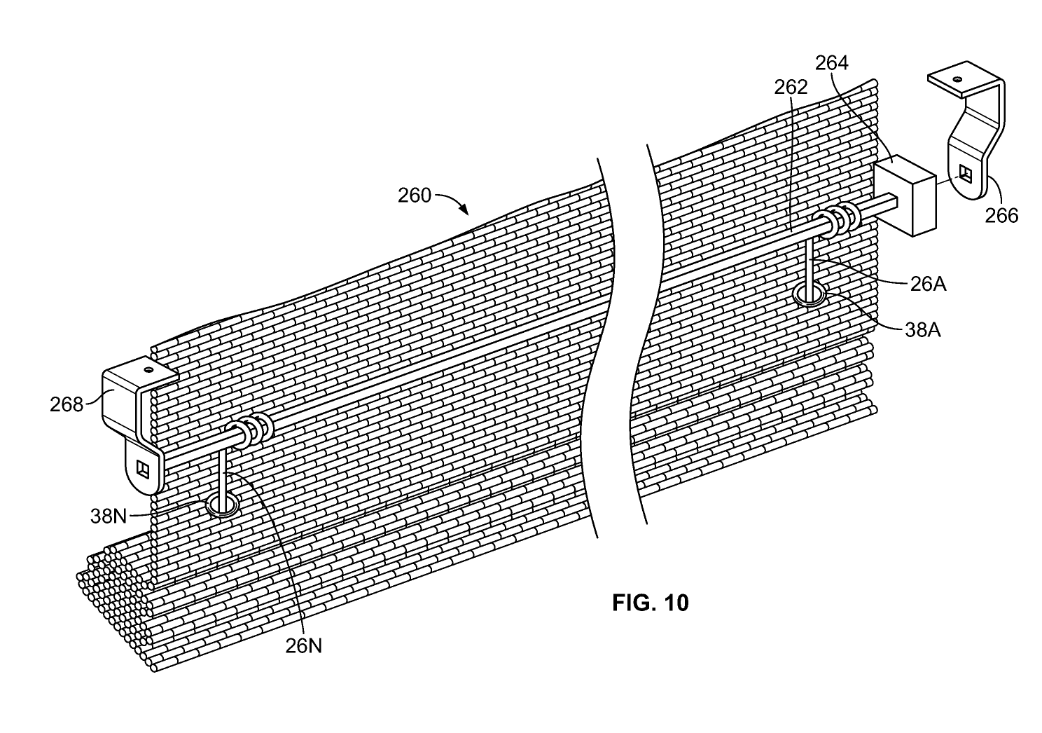

Still further, the roller 23 may be replaced by a stationary housing and rotatable element(s) may be disposed within the housing to which the cords 26A, 26B are secured and about which the cords 26A, 26B are wound. As yet another alternative, the roller 23 may be replaced by a shaft that is journaled in the window frame or between two other elements for rotation. Such an arrangement is shown in FIG. 10, in which a shade 260 includes a shaft 262 and a combined spring/clutch mechanism 264 mounted between mounting brackets 266, 268. As in the previous embodiments, the brackets 266, 268 are secured in any suitable fashion to a window casing, and cords 26A, 26B, . . . , 26N are secured in any suitable manner to the shaft 262 (such as through bores in the shaft 262 and knotted to prevent removal therefrom). The cords 26 may be wound directly around the shaft (as shown) or about one or more elements carried by the shaft. This embodiment otherwise operates exactly as the embodiment of FIG. 9 with the spring-loading and the clutch operation provided by the mechanism 264. Of course, such operation may be provided by separate clutch and one or more springs, as described previously.

While the springs described hereinabove are shown as coil springs, any of the springs disclosed herein may comprise flat springs as illustrated by the spring 215 of FIG. 8. As should be evident, any type of spring(s) suitable for the purpose of providing a counteracting force to oppose the weight of the shading material may be used, including, but not limited to torsion springs, tensioning springs, compression springs, or the like.

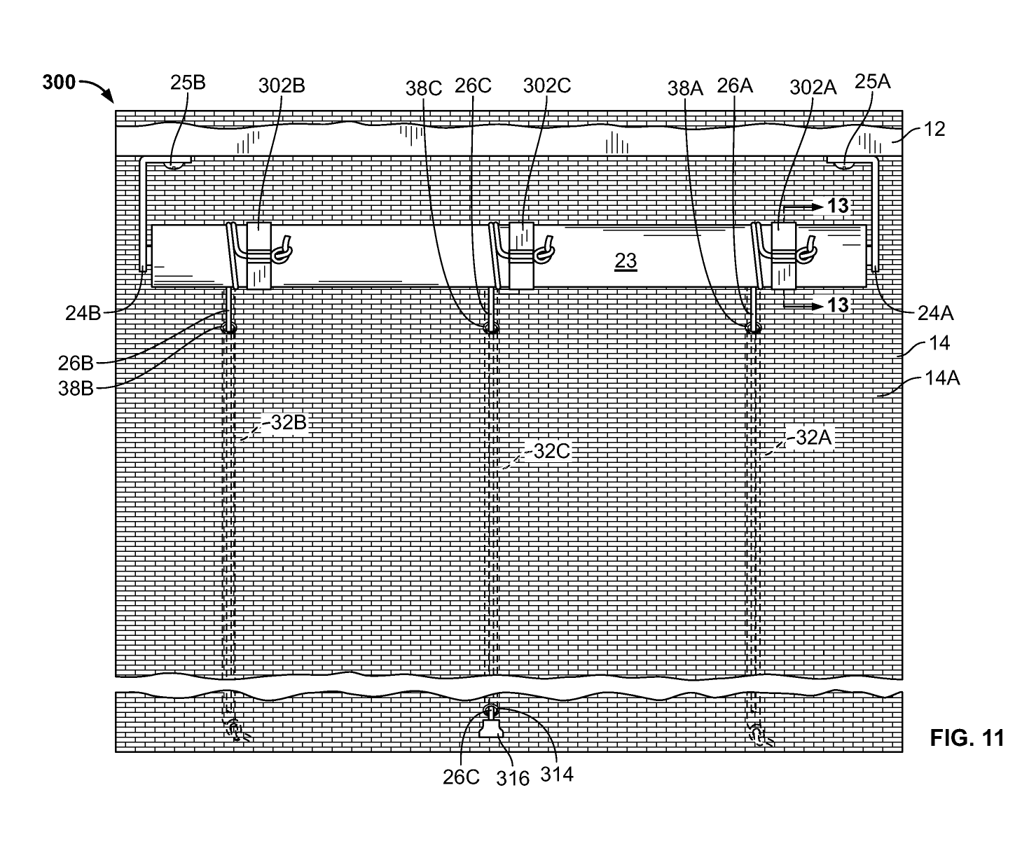

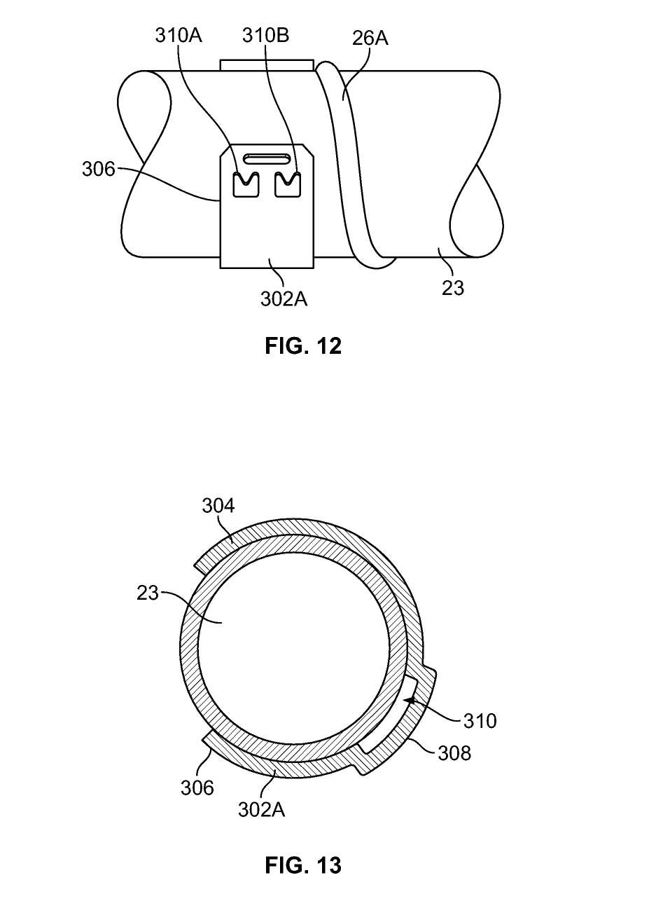

FIGS. 11-13 illustrate yet another embodiment wherein three cords 26A, 26B, 26C extend through shrouds 32A, 32B, 32C, respectively, and grommets 38A, 38B, 38C, respectively. The cords 26A-26C are wound about the roller 23 at spaced locations and are secured to the roller 23 by clips 302A-302C, respectively. (The brackets 24A, 24B are shown as being of L-shape in FIG. 11, it being understood that the brackets 24 may be of any desired shape in any of the embodiments disclosed herein). The clips 302A-302C are identical, and hence only the clip 302A is described in detail herein. As seen in FIG. 13, the clip 302A includes first and second arms 304, 306 and an intermediate portion 308 of increased diameter relative to the arms 304, 306. The intermediate portion 308 defines a circumferential space 310 through which the cord 26A may extend. The cord 26A may be knotted about the intermediate portion 308 or may be knotted to itself on a side of the portion 308 to secure the cord 26A to the roller 13. Each of the arms 304, 306, for example the arm 306 as seen in FIG. 12, includes one or more spiked portions 310A, 310B, that may be bent into engagement with the roller 23 to secure the clip 302A against rotation relative to the roller 23.

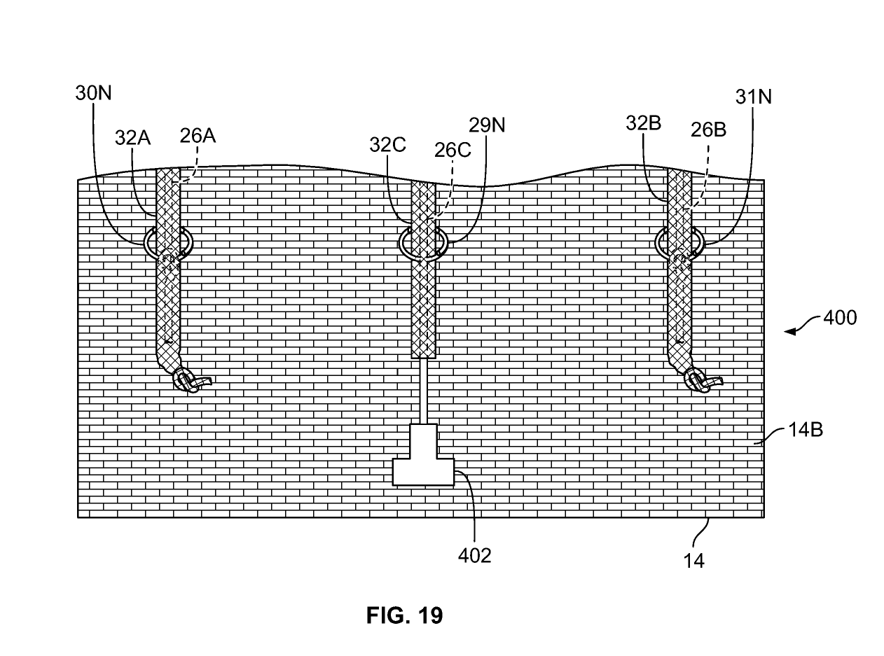

The cord 26C extends downwardly through the shroud 32C, exits the shroud 32C and extends outwardly through a further grommet 314 where it is accessible at the front face 14A of the material 14. A bell-shaped handle 316 made of wood, plastic, or any other suitable material may be secured to the cord 26C in any suitable manner, such as by extending the cord 26C through a bore in the handle 316 and knotting the cord 26C, to assist a user in actuating the shade 300. The shroud 32C and cord 26C is preferably secured using cord guides 29A, 29B, 29C, . . . , 29N (see, for example, FIG. 19) as disclosed in any of the embodiments hereinabove to spaced points of the rear face 14B of the material 14 similar or identical to the connection of the shrouds 32A, 32B and the cords 26A, 26B.

In use, a user grasps the handle 316 and pulls downwardly, thereby releasing the clutch mechanism in the roller 23 and causing the roller 23 to rotate and thereby wind or unwind the cords 26. The user can prevent further winding or unwinding of the cords 26 by exerting a downward force on the cord 26C via the handle 316, thereby stopping the rotation of the roller 23 and permitting positioning of a lower edge of the shade 300 at a desired height.

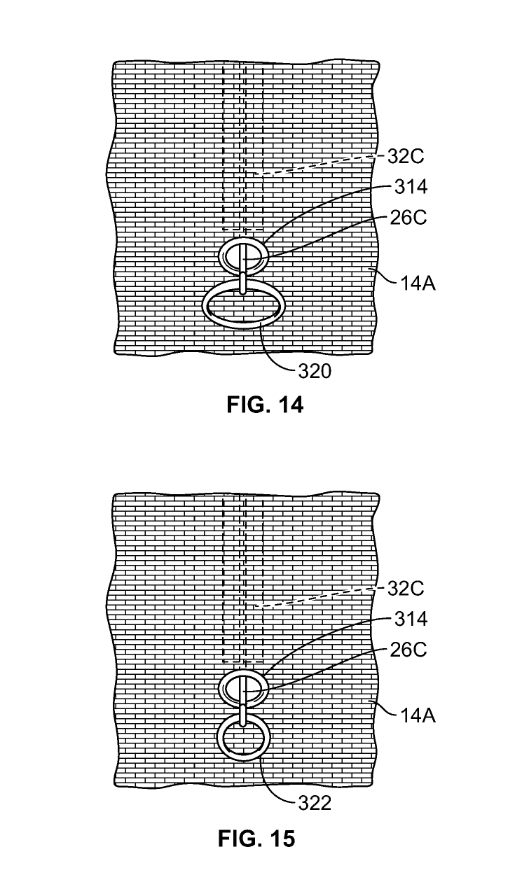

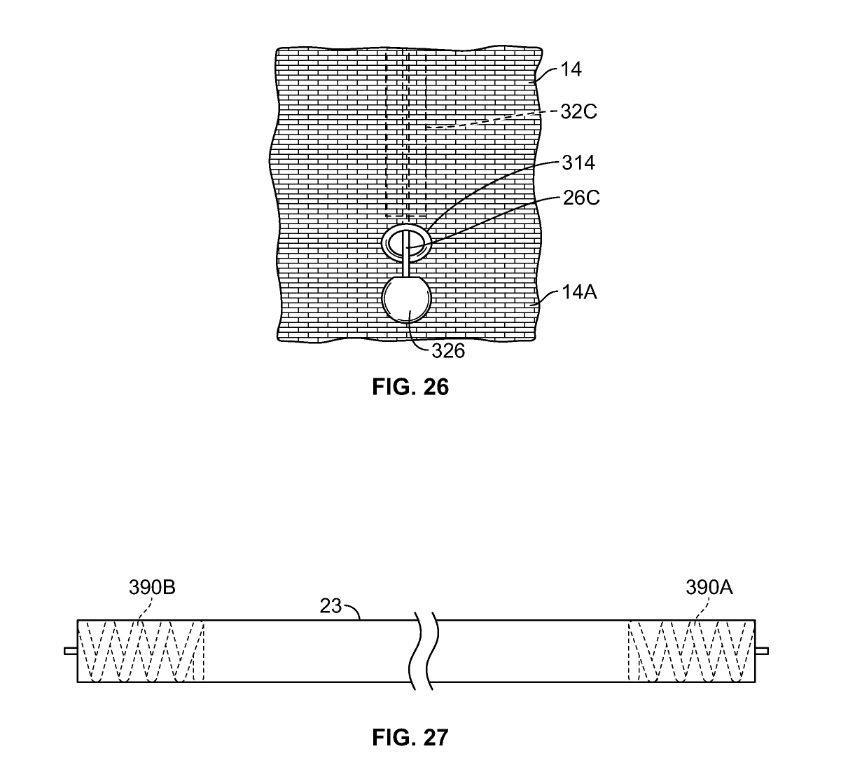

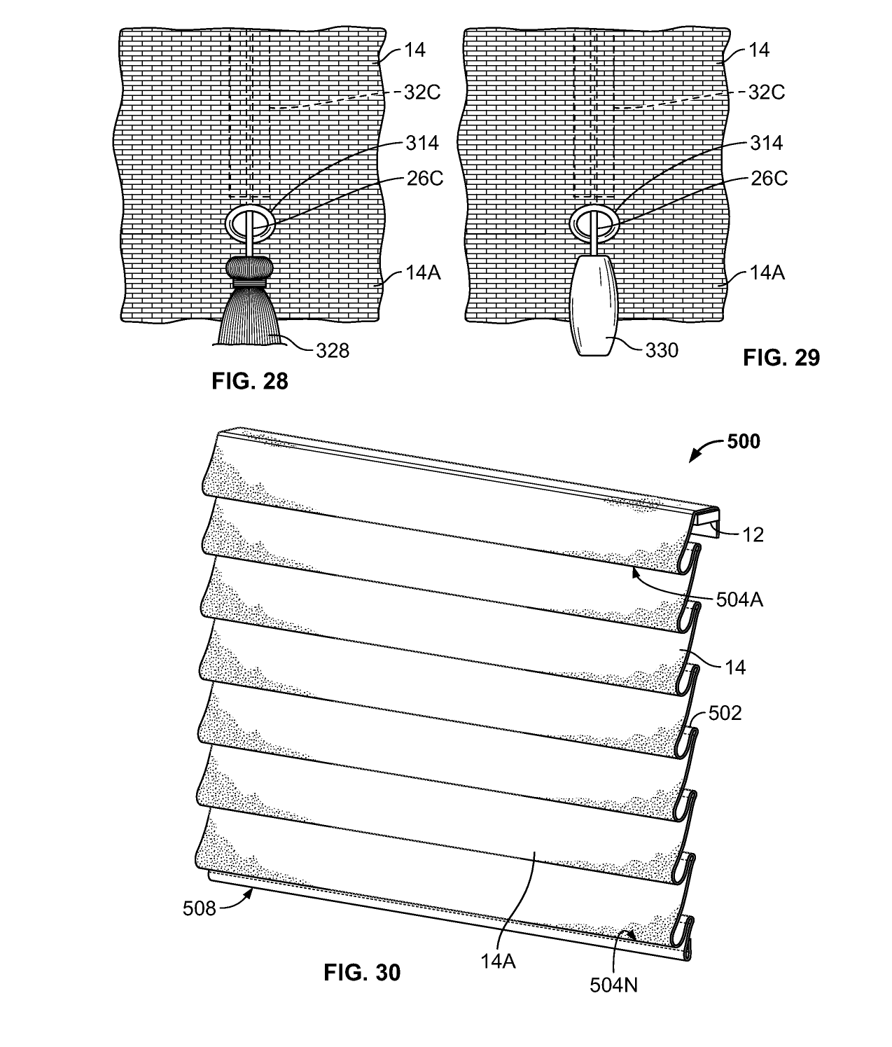

If desired, the raising and lowering operation may occur in response to force being applied to one of the other cords 26A or 26B, in which case such cord extends through a grommet appropriately positioned in the material 14 so that the cord is accessible from the front of the shade 300. Still further, with reference to FIGS. 14, 15, and 25, the bell-shaped handle 316 may be replaced by other handle(s), such as an oval-shaped handle 320 (FIG. 14), a circular-shaped handle 322 (FIG. 15), a partial dumbbell-shaped handle 324 (FIG. 25), a truncated or non-truncated ball-shaped handle 326 (FIG. 26), a tassel 328 (FIG. 28), a partial oval solid knob 330 (FIG. 29), etc.

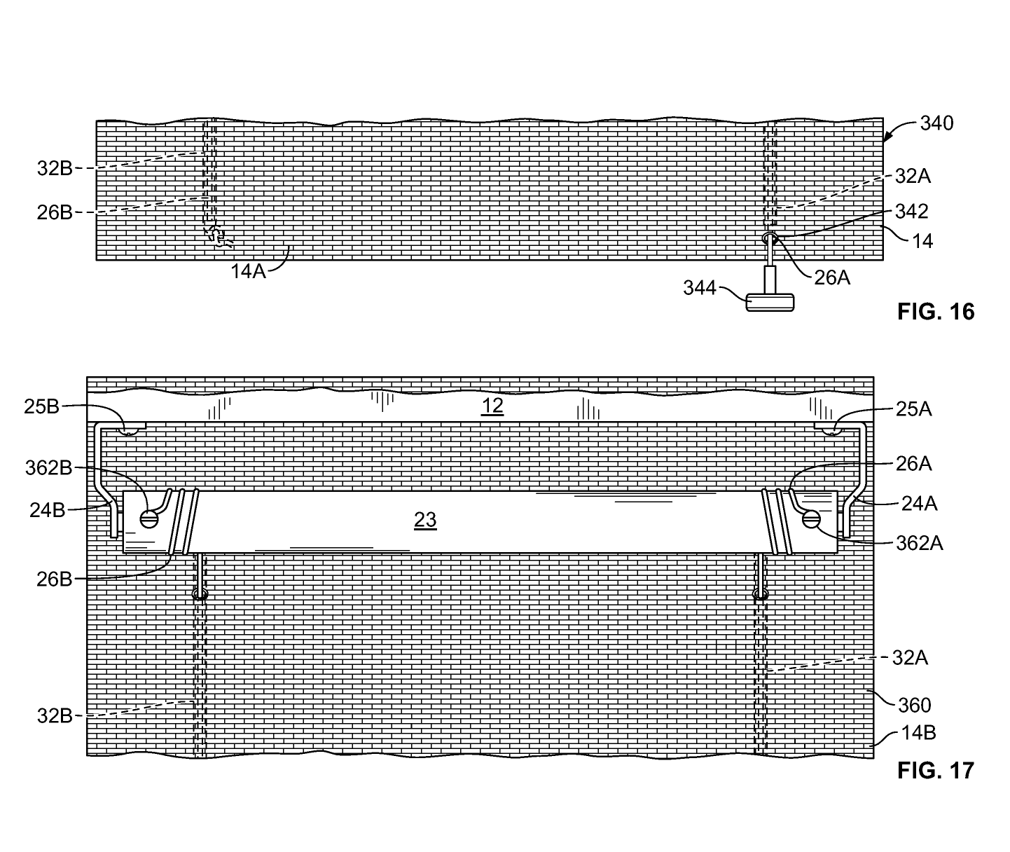

FIG. 16 illustrates a shade 340 that includes the cords 26A, 26B encased in the shrouds 32A, 32B, respectively. Though not shown in FIG. 16 (and other FIGS.), the cords and shrouds of any or all of the embodiments disclosed herein, including the cords 26A, 26B and shrouds 32A, 32B, are preferably secured using cord guides 31A, 31B, 31C, . . . , 31N and 30A, 30B, 30C, . . . , 30N as disclosed in any of the embodiments hereinabove to spaced points of the rear face 14B of the material 14. The cord 26A extends outwardly from the shroud 32A at a lower end thereof and further extends through a grommet 342 in the material 14 such that the cord 26A is accessible from the front face 14A of the material 14. A T-shaped handle 344 is secured by any convenient means (such as by a knot as described above) to the cord 26A. Although not shown, the cords 26A, 26B are wound about a roller 23 as in any of the preceding embodiments and are secured thereto to permit the handle 344 to be grasped and pulled downwardly, and thereby permit take-up of the cords 26A, 26B so that the shading material 14 can be positioned at any desired height. As in all of the embodiments descried herein, the shrouds 32A, 32B and cords 26A, 26B are secured at spaced points to the rear face 14B of the material 14 to prevent a dangerous loop from being formed.

FIG. 17 illustrates an alternative manner of attachment of the cords 26 to the roller 23. In the illustrated embodiment, a shade 360 otherwise similar or identical to any of the embodiments disclosed above, includes a roller 23 having first and second fasteners in the form of screws 362A, 362B that extend into the roller 23 and anchor the cords 26A, 26B thereto. Any other suitable fastener or other device may be used to anchor the cords 26A, 26B, as desirable.

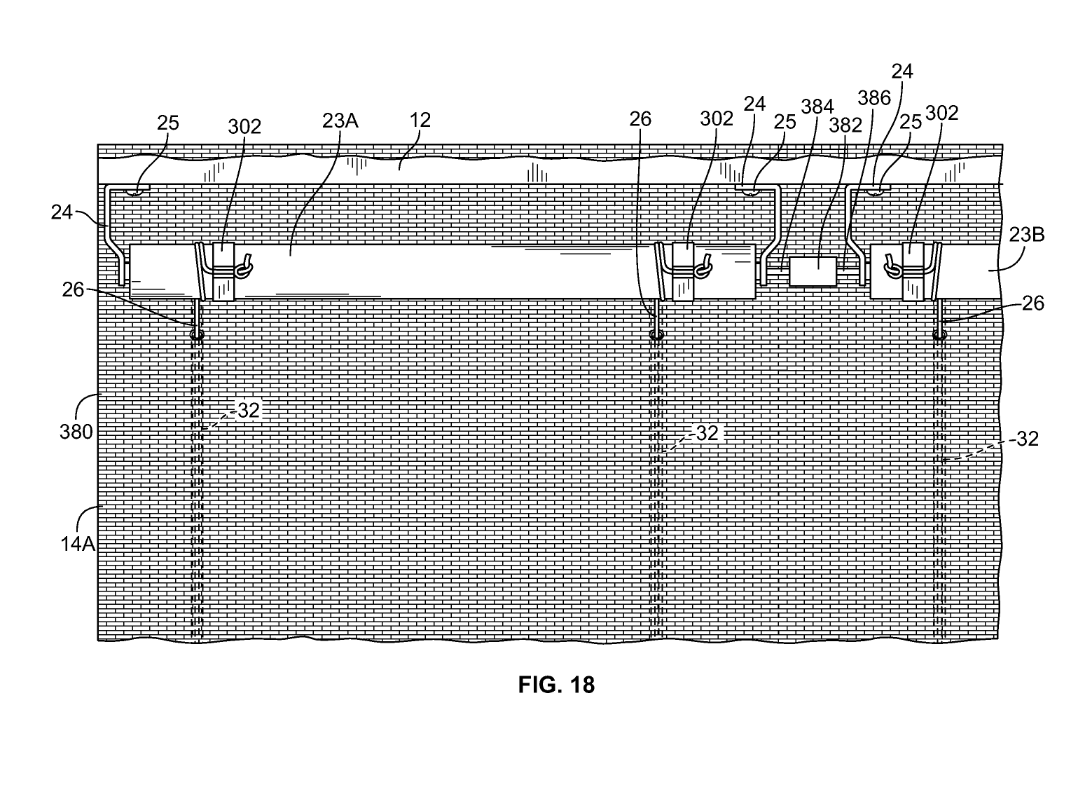

FIG. 18 illustrates a shade 380 of substantial width. In this embodiment, two or more rollers 23A, 23B, . . . , 23N (only the rollers 23A and 23B are shown) are suspended from the head rail 12 by brackets 24, as the other embodiments described herein. Cords 26 extend through shrouds 32 and are further anchored to the rollers 23 by clips 302, as described in connection with the embodiment of FIG. 11. The rollers 23 are connected together for common movement by a gearbox or other transmission member 382 that is connected by shafts 384, 386 between adjacent rollers 23. The embodiment of FIG. 18 otherwise is similar or identical to the embodiments of the preceding figures.

Alternatively, the cords 26 of the shade 380 may be wound about a single roller having one or more internal or external torsion springs that provide sufficient spring force to lift the material 14. For example, as seen in FIG. 27, a single roller 23 may include a pair of internal springs 390A, 390B that are coiled in opposite directions and are disposed in opposite ends of the roller 23. The springs 390A, 390B exert forces in an upward direction to counteract the substantial weight of the material 14. It should be noted that the clutch mechanism that allows the material 14 to be positioned at a desired height is not shown in FIG. 27.

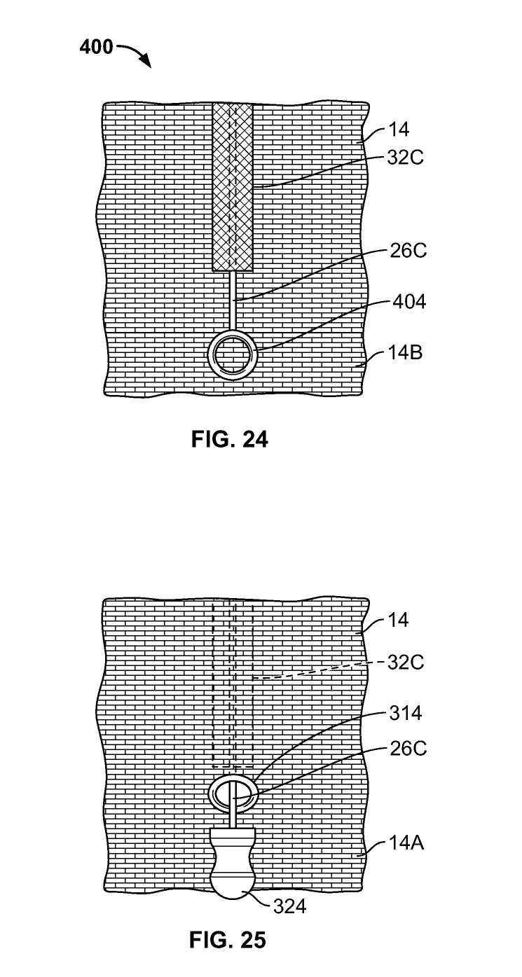

FIGS. 19-24 illustrate embodiments whereby a handle or other actuating member is accessible from the rear face 14B of the material 14. For example, with reference to FIG. 19, a shade 400 includes a T-shaped handle 402 secured in any suitable manner (such as by a knot) to the cord 26C. As seen in FIG. 24, the T-shaped handle 402 may be replaced by a ring 404 (or any other handle including, but not limited to, the handles disclosed in any of the embodiments described herein) that is tied to or otherwise secured to the cord 26C (or any other cord). In use, a user reaches behind the shade 400 and grasps the handle 402 or 404. The user may then pull down on the handle 402 or 404 to raise or lower the shade in the manner described previously.

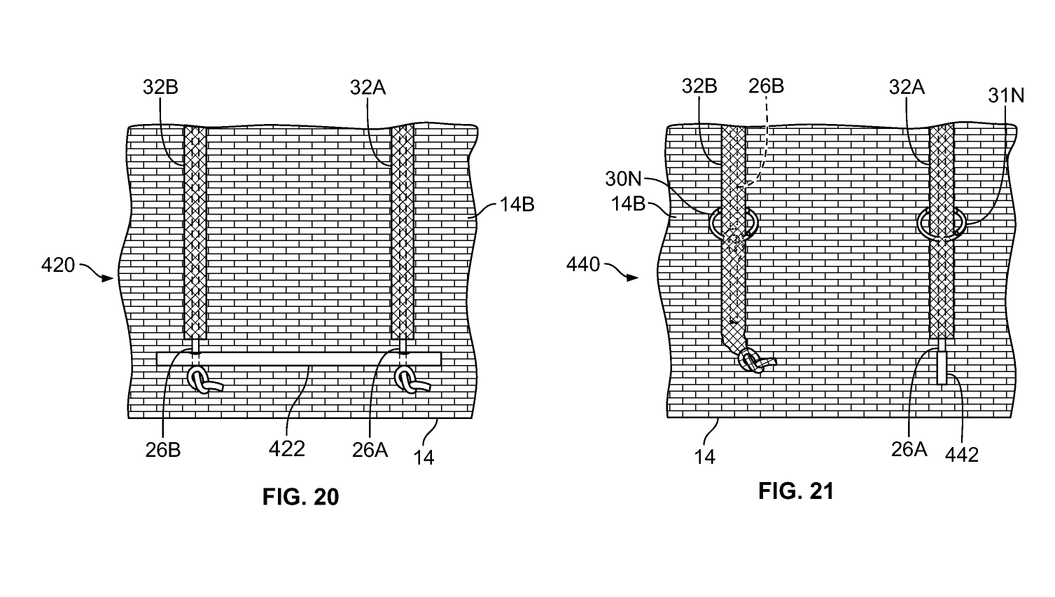

FIGS. 20 and 21 illustrate alternative arrangements to that shown in FIG. 19. In FIG. 20, as in FIG. 19, the cords 26A, 26B and shrouds 32A, 32B are preferably secured using cord guides 31A, 31B, 31C, . . . , 31N and 30A, 30B, 30C, . . . , 30N as disclosed in any of the embodiments hereinabove to spaced points of the rear face 14B of the material 14. FIG. 20 illustrates a shade 420 that includes a handle in the form of a bar 422 that spans the space between the cords 26A, 26B. The cords 26A, 26B may extend through spaced bores in the bar 422 and may be knotted or otherwise secured in any suitable fashion to fix the bar 422 to the cords 26A, 26B. In this embodiment, a user may reach behind the shade 420, grasp the bar 422, and pull downwardly as described previously to adjust the height of the shade 420.

FIG. 21 illustrates a shade 420 including a handle in the form of a cylinder 442 made of acrylic plastic or other material wherein the cord 26A (or any other cord 26) extends partially or fully through a bore in the cylinder 442 and is knotted thereto. Though not shown, the cords 26A, 26B and shrouds 32A, 32B are preferably secured using cord guides 31A, 31B, 31C, . . . , 31N and 30A, 30B, 30C, . . . , 30N as disclosed in any of the embodiments hereinabove to spaced points of the rear face 14B of the material 14. Again, the cylinder 442 is grasped and pulled downwardly by a user to raise or lower the shades 440.

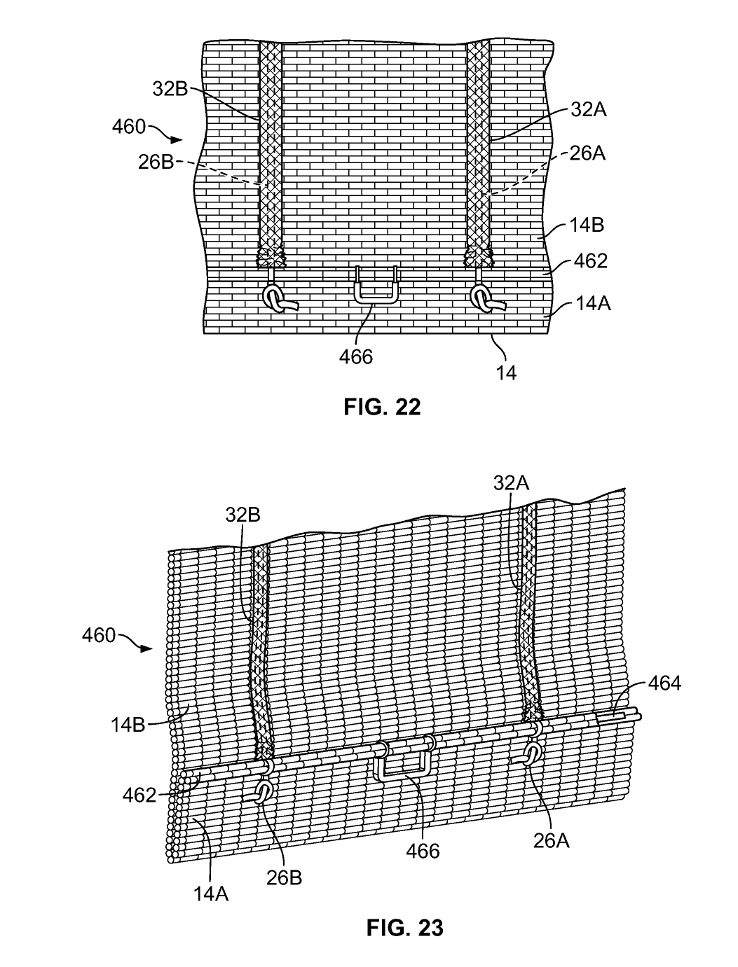

FIGS. 22 and 23 illustrate an embodiment comprising a shade 460 wherein an end 462 of the material 14 is hemmed or otherwise folded back and joined to itself to create a pocket that receives a stiffener, such as a wooden or plastic rod 464 (FIG. 23). The stiffener 464 is retained in the hemmed end 462 in any suitable fashion, such as by stitching the side edges of the end 462 shut. The cords 26A, 26B are looped around the hemmed edge 462 (the material 14 is loosely woven or otherwise can allow the cords 26 to pass therethrough) and the cords 26A, 26B are knotted or otherwise secured to the end 462. Though not shown, the cords 26A, 26B and shrouds 32A, 32B are preferably secured using cord guides 31A, 31B, 31C, . . . , 31N and 30A, 30B, 30C, . . . , 30N as disclosed in any of the embodiments hereinabove to spaced points of the rear face 14B of the material 14. A handle 466 is secured by any convenient means, such as a rope or thread about the end 462 (again, the material 14 permits passage of the rope or thread therethrough to permit securing of the handle 466). In use, the user reaches behind the shade 460, grasps the handle 466 and pulls downwardly to permit the material 14 to be positioned at a desired height.

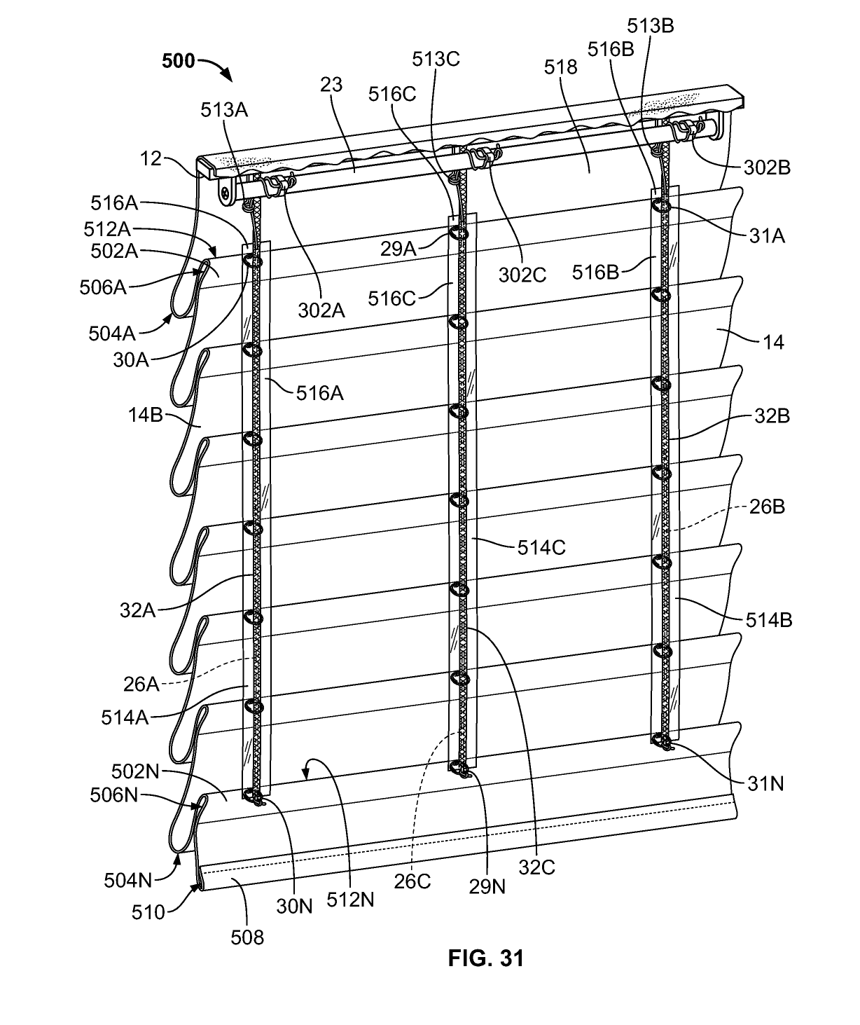

FIGS. 30 and 31 illustrate another embodiment comprising a shade 500 wherein the material 14 extends downwardly to form cascades or waterfalls of fabric off the headrail 12. The material 14 is hemmed, gathered, or otherwise folded back and joined to itself to create a series of hemmed edges 502A, 502B, . . . , 502N on the rear face 14B of the material 14 and a series of decorative folds 504A, 504B, . . . , 504N on the front face 14A of the material 14. The hemmed edges 502 create pockets 506A, 506B, . . . , 506N that may receive stiffeners, such as a wooden or plastic rod or dowel (not shown). A bottom hemmed edge 508 also creates a bottom pocket 510 that may receive a weight bar, such as a wooden, metal, or plastic rod or dowel (not shown), to hold the bottom hemmed edge down. The cords 26A, 26B, 26C and shrouds 32A, 32B, 32C are preferably secured at spaced points on the rear face 14B of the material 14 using cord guides 29A, 29B, 29C, . . . , 29N, 30A, 30B, 30C, . . . , 30N, and 31A, 31B, 31C, . . . , 31N as disclosed in the embodiments hereinabove. Cord guides 29, 30, and 31 are attached to corresponding outer edges 512A, 512B, 512C, . . . , 512N of the pockets 506A, 506B, 506C, . . . , 506N, respectively. The shrouds 32 are attached at one end to the head rail 12 and at the opposite end to the cord guides 29N, 30N, 31N. The cords 26A, B, C exit the shrouds 32 just above cord guides 30A, 31A, 29A, respectively, and pass through cord brackets 513A, B, C, respectively, before wrapping around the roller 23. The cord brackets 513A, B, C can be made of any suitable material such as metal or plastic. Furthermore, the cords 26 are attached to the roller 23 at one end and, at the opposite end, the cords 26A, 26B, 26C may be knotted or otherwise secured to the cord guides 30N, 31N, 29N, respectively. Although three sets of cords, shrouds, and cord guides are shown and discussed, it is contemplated that any number of cords, shrouds, and cord guides could be used. As shown in FIG. 31, strips 514A, 514B, 514C may be used to prevent the folds 504 from flattening or straightening out. Upper ends 516A, 516B, 516C of the strips 514A, 514B, 514C, respectively, are attached to an upper portion 518 of rear face 14B of material 14. The strips 514 are disposed behind the shrouds 32, such that the strips 514 are situated between the rear face 14B of the shade material 14 and the shrouds 32. The strips 514 extend down the rear face 14B of the material 14 and are fastened by any suitable means such as stitching or glue to the outer edges 512 of the pockets 506 at fixed points. The strips 514 may be made of a durable and flexible light-weight material such as a suitable plastic or fabric. Although three strips 514A, 514B, 514C are disclosed, it is contemplated that any number of strips 514 may be used.

A roller, shaft, or any of the aforementioned mechanisms used to raise or lower the shade can be used with the embodiment shown in FIGS. 30 and 31. Specifically, in this embodiment the roller, shaft, or other mechanism is attached to the underside of the headrail 12 and is disposed adjacent the rear face 14B the material 14 so that the front face 14A of the material falls unobstructed from the headrail 12 to create a continuous waterfall. Alternatively, the roller, shaft, or other mechanism may be disposed adjacent the front face 14A of the material 14, and a valance (not shown) may drape downwardly in front of the headrail to hide same. Moreover, any one of the aforementioned handle types and styles may be used with the shade embodiment shown in FIGS. 30 and 31.

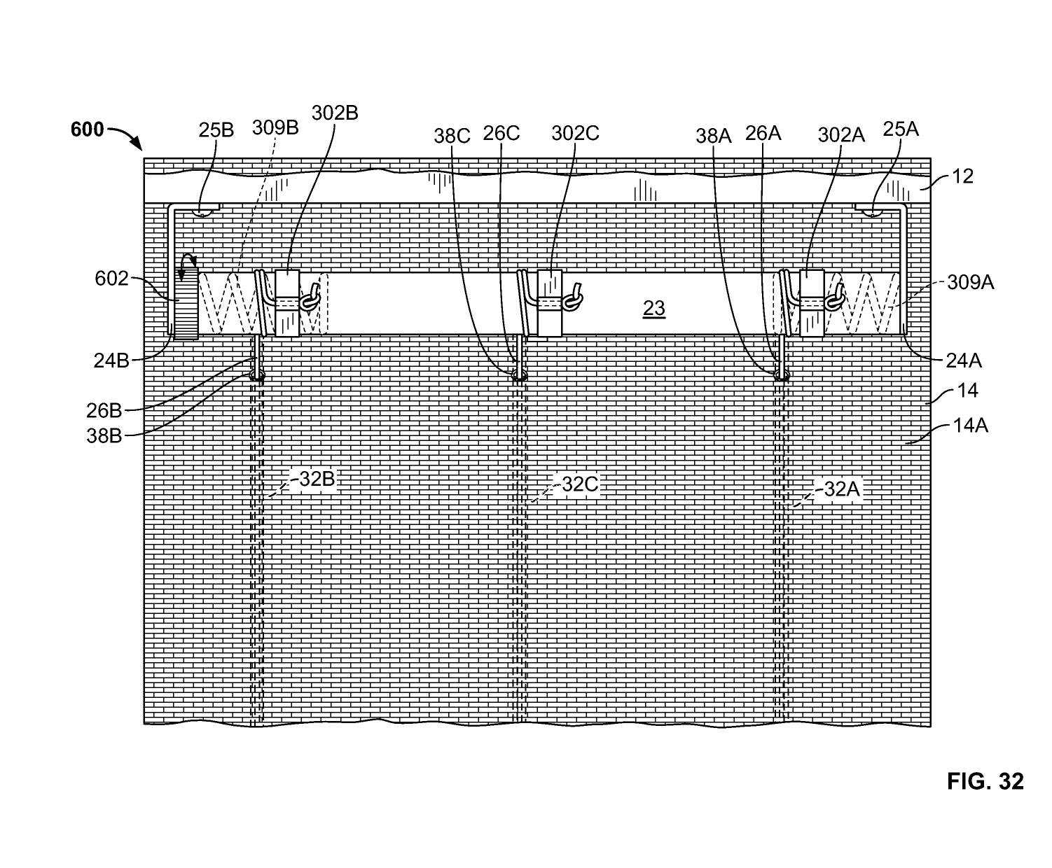

FIG. 32 illustrates another embodiment comprising a shade 600. In this embodiment, the roller 23 is fitted with a ribbed wheel 602 at one end of the roller 23, adjacent the bracket 24. The ribbed wheel 602 is provided to enable a user to adjust the tension of the springs 309A, 309B in the roller 23 to accommodate material 14 that is of varying weights. Although shown in FIG. 32 with the roller 23 and springs 309A, 309B, the ribbed wheels 602 can be used with any of the aforementioned spring-loaded mechanisms used to lower and raise the shade. Furthermore, an additional ribbed wheel 602 may be used depending on the number of springs that may require adjustment.

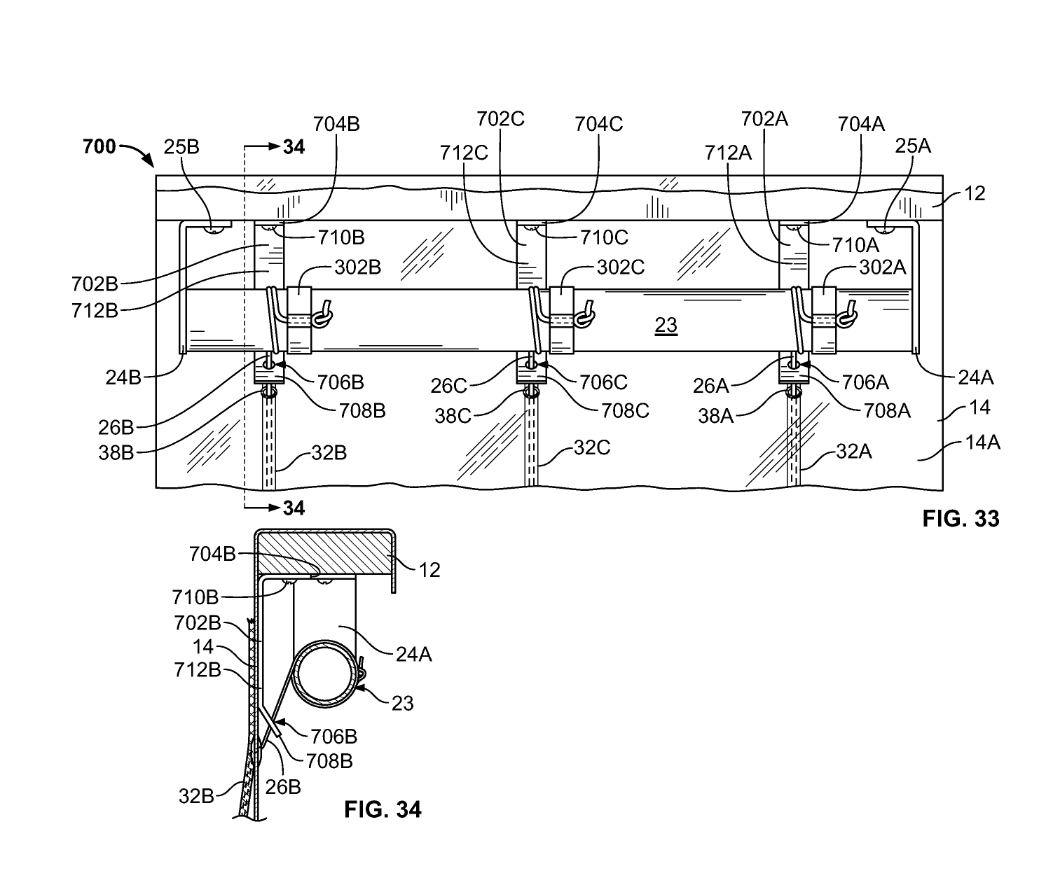

FIGS. 33 and 34 illustrate another embodiment comprising a shade 700. In this embodiment, stop brackets 702A, 702B, 702C are fastened to the headrail 12 on top ends 704A, 704B, 704C, respectively, and include bores 706A, 706B, 706C on bottom ends 708A, 708B, 708C, respectively. The stop brackets 702A, 702B, 702C are made of any durable material such as metal or plastic and are attached to the headrail 12 by any suitable fasteners such as screws 710A, 710B, and 710C, respectively. As shown in FIG. 34, the stop brackets 702 have a general “L” shape with bottom ends 708A, 708B, 708C being disposed at a slight angle with respect to a downwardly depending leg 712A, 712B, 712C of each stop bracket 702A, 702B, 702C, respectively. The downwardly depending legs 712 of each stop brackets 702 are disposed between top end 704 and bottom end 708, respectively, and are disposed substantially perpendicular to top ends 704. Alternatively, the stop brackets 702 may be of another suitable size and shape. Cords 26A, 26B, 26C are attached to the roller 23 with corresponding clips 302A, 302B, 302C (as shown in FIGS. 11-13) and are threaded through the bores 706A, 706B, 706C, respectively, into shrouds 32A, 32B, 32C, respectively. The stop brackets 702 are provided to prevent shade material that is light-weight or delicate from being rolled-up onto the roller 23. Specifically, as the cords 26 wind around the roller 23, the bottom ends 708 of the stop brackets 702 prevent the shade material 14 from being carried with the cords 26, thereby enabling the cords 26 to continue to move toward the roller unrestricted. Although three stop brackets 702A, 702B, 702C are shown in FIG. 33, any number of brackets may be used. Furthermore, the stop brackets may be used in conjunction with any of the embodiments disclosed herein.

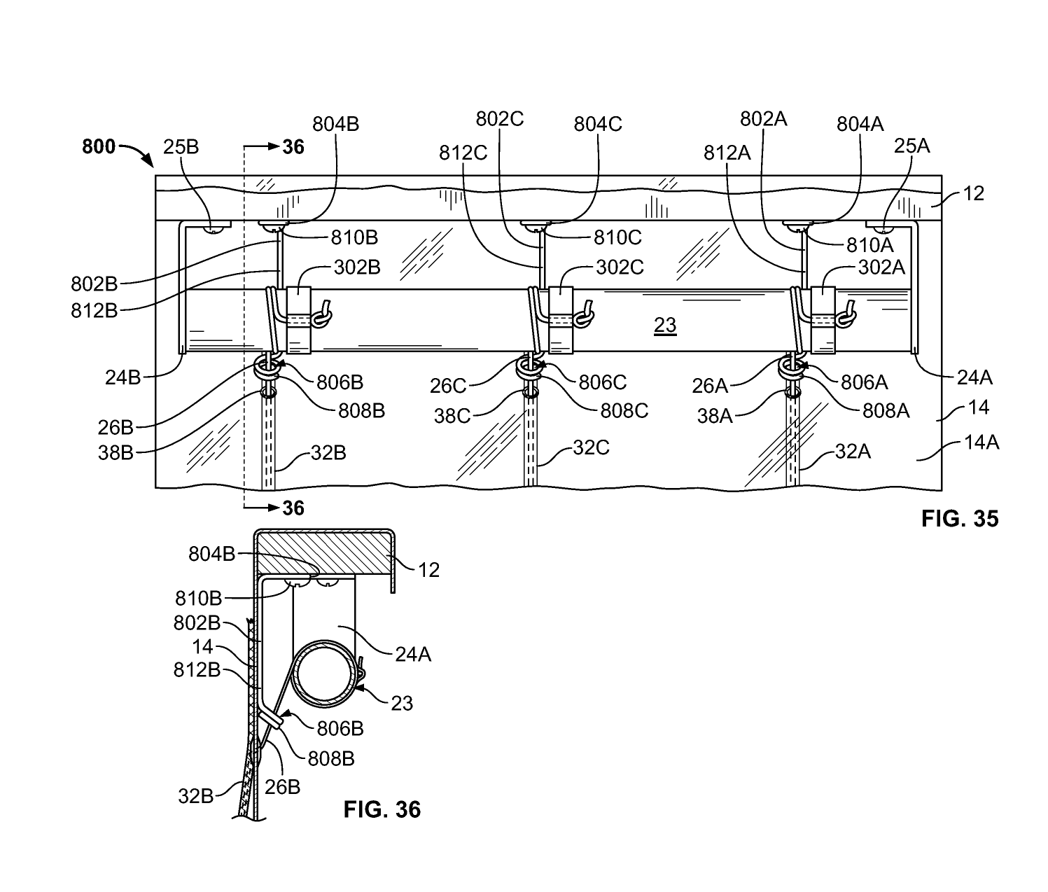

FIGS. 35 and 36 illustrate an embodiment of a shade 800 including an alternate embodiment of the stop brackets discussed above. As before, the stop brackets are provided to prevent shade material that is light-weight or delicate from being rolled-up onto the roller 23. In this embodiment, the stop brackets 802A, 802B, 802C have top ends 804A, 804B, 804C and are made of a continuous piece of flexible metal or wire, which is bent or otherwise formed to create holes or bores 806A, 806B, 806C on bottom ends 808A, 808B, 808C, respectively. The stop brackets 802 are attached to the headrail 12 at top ends 804A, 804B, 804C by any suitable fasteners such as screws 810A, 810B, and 810C, respectively. As shown in FIG. 36, the stop brackets 802 have a general “L” shape with bottom ends 808 being disposed at a slight angle with respect to a downwardly depending leg 812A, 812B, 812C of each stop bracket 802A, 802B, 802C, respectively. The downwardly depending legs 812 of each stop brackets 802 are disposed between top end 804 and bottom end 808, respectively, and are disposed substantially perpendicular to top ends 804. Alternatively, the stop brackets 802 may be of another suitable size and shape. Cords 26A, 26B, 26C are attached to the roller 23 with corresponding clips 302A, 302B, 302C (as shown in FIGS. 11-13) and are threaded through the bores 806A, 806B, 806C, respectively, into shrouds 32A, 32B, 32C, respectively.

To assemble and use the window shade 700/800, a user obtains a stop bracket 702/802. The top end 704/804 of the stop bracket 702/802 is attached to the headrail 12. Preferably, the top end 704/804 is positioned adjacent the headrail 12 so that the bottom end 708/808 of the stop bracket 702/802 is disposed between the roller 23 and the shade material 14. A fastener 710/810 is then inserted through the top end 704/804 into the headrail 12. The cord 26 may then be threaded through the bore 706/806 and pulled to raise the shade material 14.

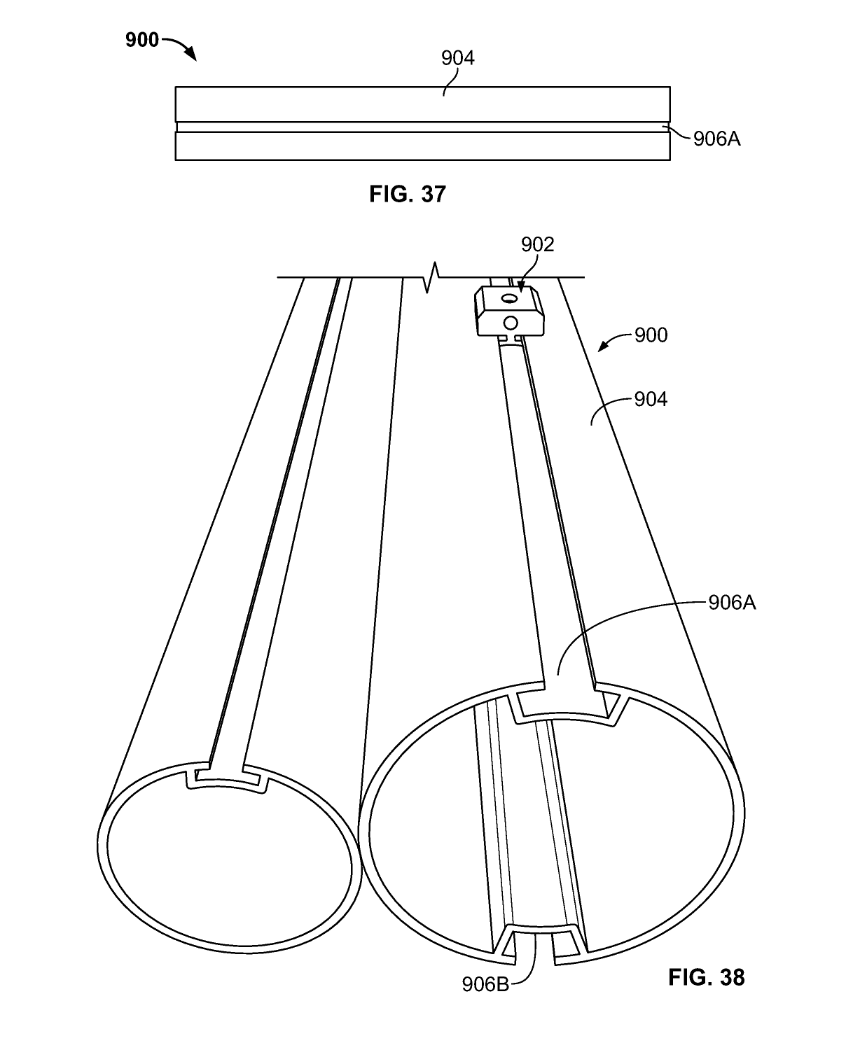

FIGS. 37-40 show another embodiment of a roller 900 and a cord attachment member 902 that can be used to secure one end of the cord 26 to the roller. The roller 900 and cord attachment member 902 can be used in place of the roller 23 and clips 302 in any one of the shade embodiments mentioned above. As shown in FIGS. 37-38, the roller 900 consists of a hollow tube 904, which can be made of any suitable material such as a strong, light-weight metal, e.g., aluminum, or plastic. The hollow tube 904 may have different diameters to accommodate shade materials of different lengths and weights and may be painted, tinted, coated, or dyed in different colors. Two channels 906A,B are disposed in the hollow tube 904 at locations diametrically opposite to each other. The channels 906A, B are defined by two walls that protrude into an interior of the hollow tube 904, and one or more cord attachment members 902 engage and are retained within such walls.

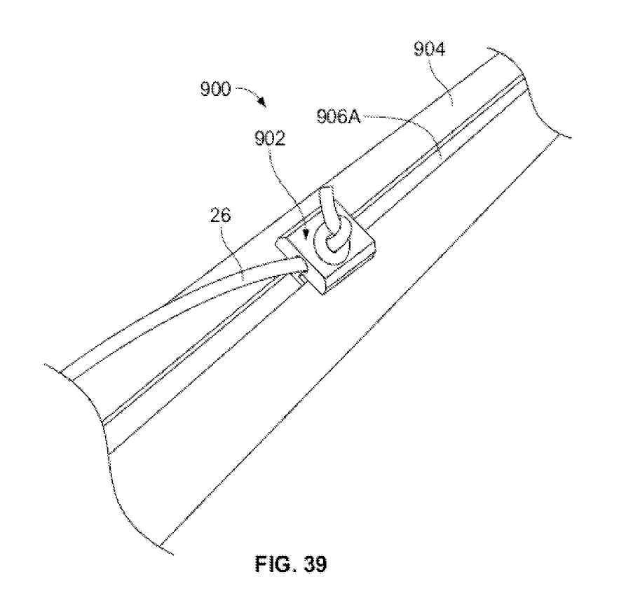

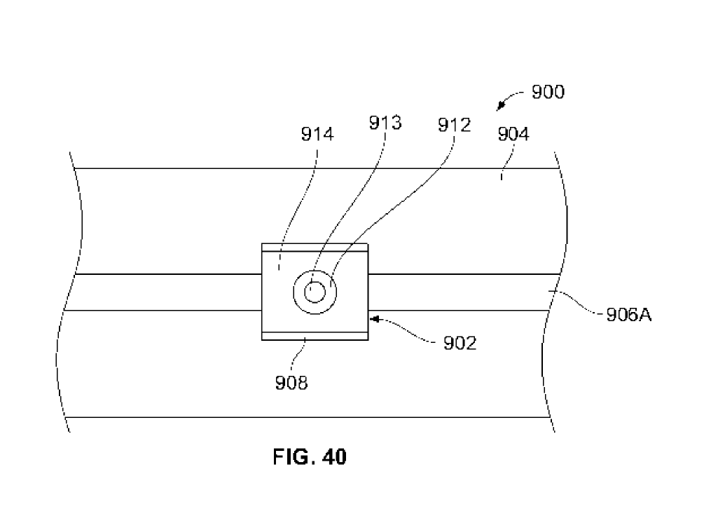

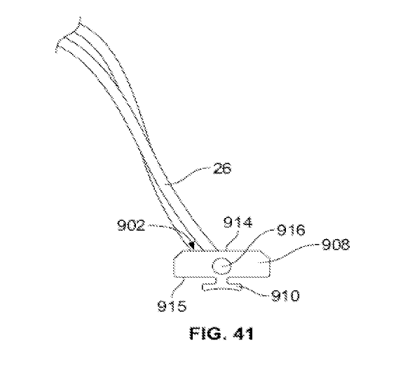

FIGS. 39 and 40 show the cord attachment member 902 attached to the hollow tube 904 via the channel 906A. FIG. 39 shows the cord attachment member 902 with a cord 26 attached and FIG. 40 shows the cord attachment member 902 without a cord 26 attached to the attachment member.

FIG. 41 shows a side view of the cord attachment member. The cord attachment member 902 has a first portion 908 and second portion 910. The first portion 908 may be of any shape that is suitable to rest atop the channel 906. Here the first portion 908 is shown to be substantially rectangular in shape.

The first portion 908 includes a first hole 912 located on a top 914 of the first portion 908. The cord hole 912 extends through the first portion 908 until it reaches a center potion. The first portion 908 also contains a threaded screw hole 913 (shown in FIG. 40), disposed directly below the cord hole 912. The screw hole 913 has a diameter shorter than that of the cord hole 912 and extends from the center portion of the first portion 908 through to a bottom potion 915 of the first potion 908.

As best shown in FIG. 41, a bore 916 is located on a side of the first portion 908. The bore 916 extends through the entire length of the first portion 908 and intersects the cord hole 912 and the screw hole 913 at the center portion of the first portion 908. The intersection of the cord hole 912 and bore 916 provide a channel through which the cord 26 can be passed. The cord first enters the bore 916 and then is passed through the cord hole 912. The diameter of the bore 916 is shorter than the diameter of the cord hole 912 so that when an end of the cord is tied into a knot after being passed through the cord hole 912, the knot can partially lie within the cord hole 912, but cannot pass through the bore 916.

The second portion 910 of the cord attachment member 902 may be shaped in any suitable manner to enable the cord attachment member 902 to movably engage the channel 906. As best shown in FIG. 41, the second portion 910 in this embodiment is shaped like an upside down “T” and has a slight curve on the horizontal cross member of the “T”. The second portion 910 is attached to the hollow tube 904 by sliding the second portion 910 into the channel 906 on one end of the hollow tube 904. Once the attachment member 902 is slid into place, a set screw or other suitable fastener is inserted through the cord hole 912 and into threads in the screw hole 913. As the screw or other fastener is screwed into the threads, the second portion 910 is pushed against the upper walls of the channel 906 thereby forming a friction-fit connection, which prevents the attachment member 902 from moving about.

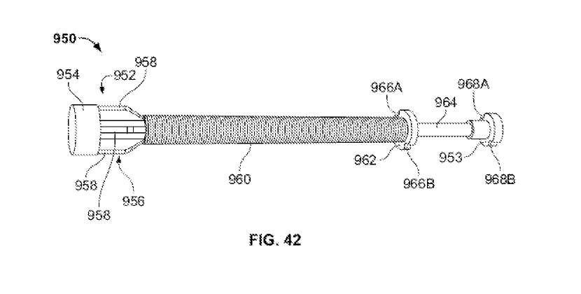

FIG. 42 shows an embodiment of a spring-loaded mechanism 950, which can be inserted into the roller 23/900. The spring mechanism 950 is provided in various sizes and strengths to accommodate varying weights of the shade material. Furthermore, the spring-loaded mechanism 950 may be attached to side brackets 24 in the same or similar manner that discussed in relation to spring-loaded rotatable spindles 21.

The spring-loaded mechanism 950 has a first end portion 952 and a second end potion 953 opposite the first end potion. The first end portion 952 comprises a wheel 954 and a securing member 956. The wheel 954 has a diameter that is the same or larger than the diameter of the roller 23, 900, and the securing member 952 has a diameter that is slightly less than the diameter of the wheel and roller. Thus, when the spring-loaded mechanism 950 is placed within a roller 23/900 the wheel 952 abuts one end of the roller and the securing member 956 is covered by the roller. Furthermore, the securing member 956 has protrusions 958, which engage an interior side of the roller 23/900.

A torsion spring 960 is attached at one end to the securing member 956 of the spring-loaded mechanism 950 and at its other end to a drive collar 962, which is disposed between the first and second end potions 952, 953. A shaft 964 is attached to the first and second end potions 952, 953 and extends through the torsion spring 960 and drive collar 962. In addition, the drive collar 962 and the second end portion 953 have identical sets of grooves 966A,B and 968A,B, respectively. The set of grooves 966A,B and 968A, B are shaped to engage the walls of the channels 906A,B and enable the torsion spring, 960, drive collar 962, and second end portion 953 to rotate together relative to the first end portion 952 when the shade is pulled down. The second end portion 953 may also be an oil brake, which is a mechanism used to slow down the uncoiling of the torsion spring, so that the roller 23/900 does not rotate rapidly and lift up the shade material 14 too quickly, which may cause damage to the shade or injury to the user. Furthermore, the drive collar 962 and the second end portion 953 also have a diameter slightly less than the roller 23/900 to enable the spring-loaded mechanism 950 to be inserted into the roller 23/900.

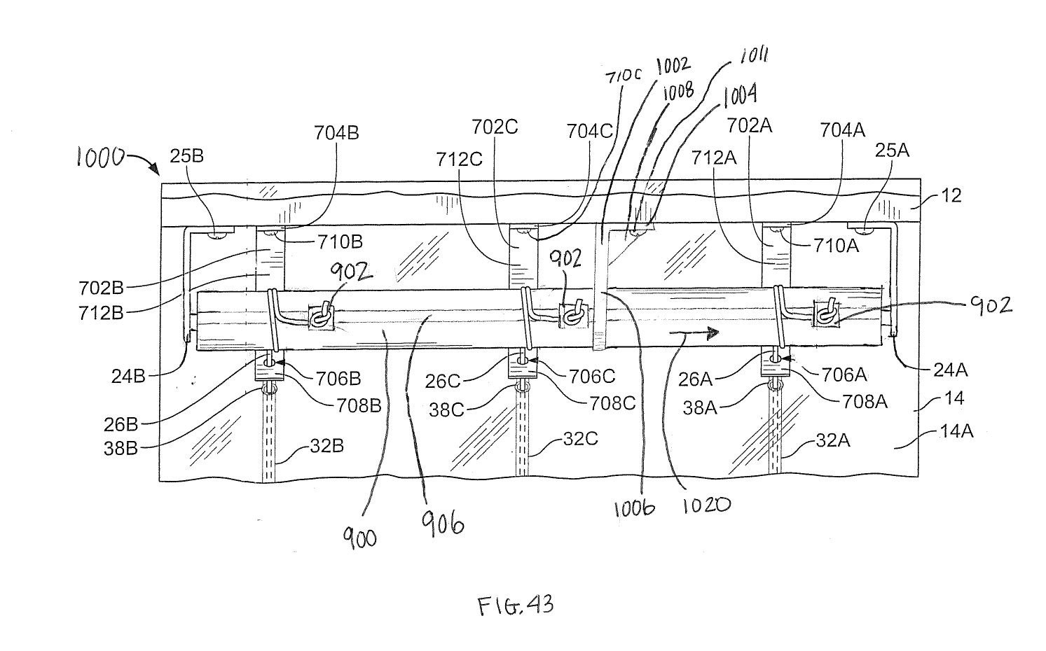

FIG. 43 illustrates another embodiment comprising a shade 1000 having a support mechanism 1002. The support mechanism 1002 provides additional vertical support to a roller when the roller is mounted to the headrail, which helps minimize or prevent the sagging or bending of the roller over time due to gravity and the downward forces exerted on the roller to raise or lower the shade material. The support mechanism 1002 may be used with any of the window shades and rollers discussed above, and may be made of plastic, metal, wood or any other suitable material. In the illustrative example, one support mechanism is disposed on the headrail 12 between a first end 901 and a second end 903 of the roller 900 discussed above. Although one support mechanism is shown, any number of support mechanisms 1002 may be used. If a single support mechanism is used, then the support mechanism is preferably disposed at or near the mid-point of the roller 900 as shown in FIG. 43.

The support mechanism 1002 includes a first portion 1004 and a second portion 1006, the second portion 1006 being disposed substantially perpendicular to the first portion 1004. The support mechanism 1002 may also include a support brace 1008 or multiple support braces 1008 to keep the first and second portions 1004, 1006 of the support mechanism 1002 perpendicular to each other. In the illustrative example, a single support brace 1008 is disposed at a midpoint along the intersection of the first potion 1004 of the support mechanism 1002 with the second portion 1006. Although the support brace 1008 is shown as having a triangular shape, the support brace 1008 may have any suitable shape, e.g., a rectangular shape. The first and second portions 1004, 1006 as well as the support brace 1008 of the support mechanism 1002 may be fabricated from a single piece of material, for example, through molding, carving, or three-dimensional printing, or may be constructed from separate pieces of material that are attached together or bonded though any known attachment device known in the art such as tape, solder, glue, or the like.

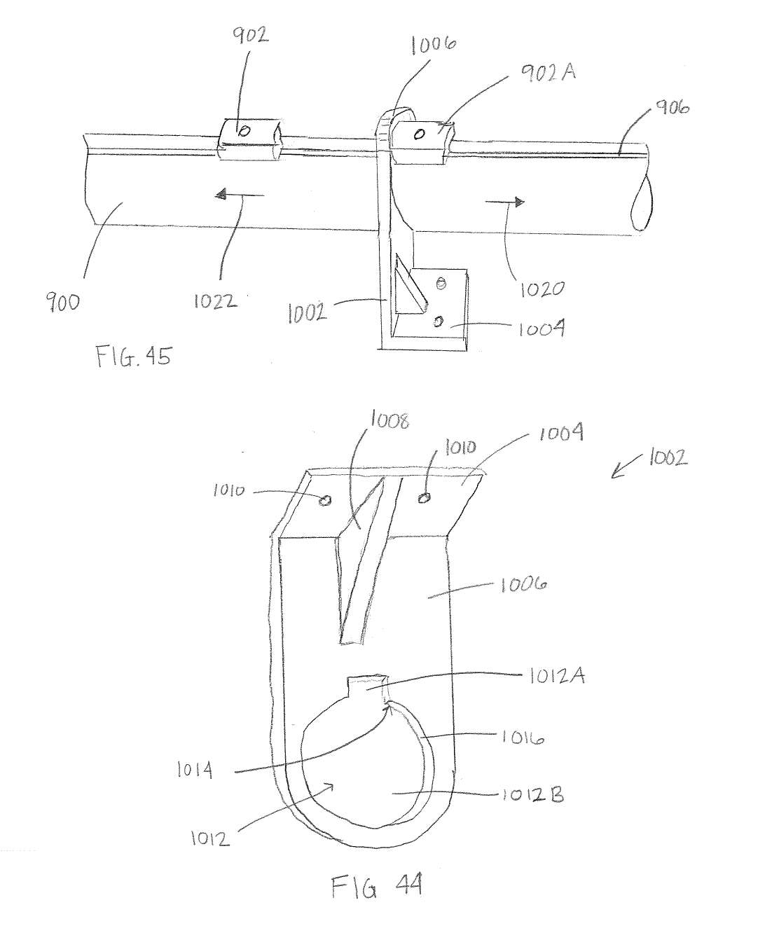

Turning to FIG. 44, the first portion 1004 of the support mechanism 1002 may include one or more holes 1010 that are configured to receive a fastener, such as a screw 1011, to mount the support mechanism 1002 to the headrail 12. For example, the holes 1010 may be smooth bores or include threads, which engage the threads of a screw.

The second portion 1006 of the support mechanism 1002 includes an opening or bore 1012. The bore 1012 may be any suitable shape that enables the support mechanism 1002 to receive the roller 900, such that the roller 900 can be slid or extended through the bore 1012. In the illustrative example, the bore is bulb-shaped. For example, the upper portion 1012A of the bore has a rectangular shape, which is disposed directly below the support brace 1008, and the lower portion 1012B of the bore has a circular shape, which is disposed below the upper portion 1012A.

In the illustrative example, the upper portion 1012A of the bore 1012 is rectangular in shape so that the support mechanism 1002 can pass over one or more cord attachment members 902 that may be mounted on the roller 900 via the channel 906. The support mechanism 1002 may be mounted on the headrail 12 before the roller 900 is slid through the support mechanism 1002, or the support mechanism 1002 may be slid onto the roller 900 before the attachment mechanism 1002 is mounted to the headrail 12.

The lower portion 1012B of the bore 1012 may engage a portion of the roller 900 when the roller 900 is mounted on the support mechanism 1002. The bore 1012 is defined by a surface 1014 that may be coated with a friction-reducing material 1016 such as a lubricant, Teflon®, or any other suitable material. Coating the surface 1014 of the bore 1012 with the friction-reducing material 1016 reduces friction between the roller and the surface 1014, thereby enabling the roller 900 to move smoothly within the bore 1012. If desired, the friction-reducing material may be dispensed with entirely, in which case the surface 1014 may comprise a smooth surface, or other friction reducing means such as linings may be used

One or more cord attachment members 902 may be disposed on the roller 900 either before or after the roller 900 is mounted on the support mechanism 1002. The cord attachment member 902 may receive the cord 26 as shown in FIGS. 39 and 43. Preferably, at least one cord attachment member 902 is fixedly placed or disposed adjacent a first side of the support mechanism 1002 as shown in FIG. 43. In this configuration, the support mechanism 1002 acts as a stop and prevents or significantly restricts lateral movement of the roller 900 in at least one direction.

For example, if through rough handling, the roller 900 comes out of bracket 24A, the roller 900, unless otherwise restrained, may move in the direction 1020 shown in FIG. 43, in turn causing the roller 900 to disengage from the bracket 24B. This is undesirable insomuch as disengagement from the bracket 24B may cause the internal spring of the roller 900 to unwind. As discussed above, one or more springs may be housed within the roller 900. Before the roller is mounted to the headrail via the brackets 24A and 24B, a biasing force is placed on the roller by winding the spring(s). The biasing force enables the roller 900 to raise or lower the shade material 14 to various positions. The brackets 24A and 24B along with other internal mechanisms keep the roller 900 in a biased state by preventing the spring(s) from returning to its natural or unwound state. If the roller comes out of the brackets 24A and 24B, then the spring(s) may unwind thereby eliminating or greatly reducing the biasing force. Restoring the biasing force to the roller 900 would require the spring(s) to be rewound, which takes time and may require the knowledge of one skilled in the art. Therefore, by using the support mechanism 1002 and cord attachment member 902 to prevent, for example, the roller 900 from disengaging the mounting bracket 24B, the amount of time and level of skill needed to install or reposition the window shade is minimized. This is especially advantageous given that many window shades are purchased and used by consumers or sales persons who may have limited knowledge with respect to spring-loaded mechanisms.

A second cord attachment member 902A may also be included as shown in FIG. 45. If a second attachment member 902A is provided, then it is preferably disposed adjacent a second side of the support mechanism 1002. Use of a second cord attachment member 902A may be desirable to prevent or significantly restrict lateral movement of the roller 900 in a direction 1022 opposite the direction 1020. Restricting lateral movement of the roller 900 in both the directions 1020, 1022 may be desirable to keep the roller 900 from disengaging from either of the brackets 24A or 24B.

### INDUSTRIAL APPLICABILITY

The shades of the foregoing embodiments are not limited to the precise details disclosed herein, but may be modified to combine aspects of one embodiment with another embodiment. The shades disclosed herein may be assembled in an automated manner or by hand, or by a combination of both techniques.

Numerous further modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications that come within the scope of the appended claims are reserved.

I claim:

1. A window shade system, comprising:
a headrail configured for mounting adjacent a window;
a rotatable roller mounted to the headrail having a first end and a second end opposite the first end; and
a support mechanism disposed between the first and second ends of the roller and having a first portion and a second portion, the first portion of the support mechanism being secured to the headrail and the second portion of the support mechanism having a bore through which the roller extends.

2. The window shade system of claim 1, wherein the bore has a surface that comes in movable contact with a portion of the roller.

3. The window shade system of claim 2, wherein the surface of the bore is coated with a friction reducing material.

4. The window shade system of claim 3, wherein the friction reducing material is Teflon.

5. The window shade system of claim 1, wherein the support mechanism is comprised of metal, plastic, or wood.

6. The window shade system of claim 1, wherein the first portion of the support mechanism has a hole adapted to receive a fastener.

7. The window shade system of claim 1, wherein the roller includes at least one channel disposed along the length of the roller.

8. The window shade system of claim 7, further including a first stop member which engages the walls defining the channel of the roller and is fixedly attached to the roller, wherein the first stop member is disposed on a first side of the support mechanism such that the first stop member engages the support mechanism when the roller moves in a first direction.

9. The window shade system of claim 8, further including a second stop which engages the walls defining the channel of the roller and is fixedly attached to the roller, wherein the second stop member is disposed on a second side of the support mechanism such the second stop member engages the support mechanism when the roller moves in a second direction, opposition the first direction.

10. The window shade system of claim 9, wherein engagement of the first stop member or the second stop member with the support mechanism stops movement of the roller in the first direction or the second direction, respectively.

11. A window shade comprising:
a headrail configured for mounting adjacent a window;
a rotatable roller mounted to the headrail;
a shading material having a first end attached to the headrail, a second end opposite the first end, and a face between the first and second ends;
a cord disposed adjacent the face and secured to the roller wherein rotation of the roller causes the cord to be wound about or unwound from the roller for moving the shading material between a stowed position in which the shading material is collected adjacent the headrail and a deployed position in which at least a portion of the shading material extends away from the headrail; and
a support mechanism disposed between a first end and a second end of the roller and having a first portion and a second portion, the first portion of the support mechanism being secured to the headrail and the second portion of the support mechanism having a bore configured to receive the roller.

12. The window shade of claim 11, wherein the bore has a surface that comes in movable contact with a portion of the roller.

13. The window shade of claim 12, wherein the surface of the bore is coated with a friction-reducing material.

14. The window shade of claim 11, wherein the first portion of the support mechanism has at least one hole adapted to received a fastener.

15. The window shade of claim 11, wherein the roller includes at least one channel disposed along the length of the roller.

16. The window shade of claim 15, further including at least one stop member that engages the walls defining the channel of the roller and is fixedly attached to the roller.

17. The window shade of claim 16, wherein the stop member is disposed adjacent the support mechanism and restricts lateral movement of the roller in a first direction.

18. The window shade of claim 17, wherein the stop member is configured to receive the cord and secures the cord to the roller.

19. The window shade of claim 11, further including first, second, and third spaced cord guides secured to and extending outwardly from the face, wherein the first cord guide is disposed at a first location, the second cord guide is disposed at a second location farther away from the headrail than the first location, and the third cord guide is disposed at a third location father away from the headrail than the first and second locations, wherein the cord is secured to the shading material at a further location farther away from the headrail than the third location and wherein each cord guide surrounds the cord.

20. The window shade of claim 19, further including a shroud defining an internal passage through which the cord extends, wherein the shroud is configured to extend longitudinally as the shade material is moved toward the deployed position and the shroud is adapted to collages longitudinally as the shade material is moved toward the stowed position wherein the shroud is unsecured to the shading material at all location between cord guides.

21. The window shade of claim 11, further including a stop bracket disposed adjacent the face having a first potion attached to the headrail and a second portion containing a bore, wherein the cord extends from the roller through the bore and is secured to the shading material.
